(19) United States
(12) Patent Application Publication
(10) Pub. No.: US 2002/0188537 A1
(43) Pub. Date: Dec. 12, 2002

(54) Management systems and methods for maximizing return on assets

(76) Inventors: Peter A. Leeds, Nashua, NH (US); Kimbo B. Mundy, Welleslley, MA (US); Girish Haran, Bedford, MA (US); Vijay C. Bhatt, Burlington, MA (US); John C. Stauffer, Framingham, MA (US); Lap Kong Cheng, Newton, MA (US)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/077,546

(22) Filed: Feb. 15, 2002

Related U.S. Application Data
(63) Continuation-in-part of application No. 09/662,737, filed on Sep. 15, 2000.
(60) Provisional application No. 60/269,128, filed on Feb. 15, 2001.
(60) Provisional application No. 60/154,667, filed on Sep. 16, 1999.

(51) Int. Cl. G06F 17/60

(52) U.S. Cl. 705/35

(57) ABSTRACT

Systems and methods increase an entity's return on assets by allowing the entity to redeploy idle and surplus assets, assist in the sale and disposal process, and provide the resources to easily locate and buy from an aggregation of idle and surplus assets. The entity may establish confidential and secure internal trading communities, private trading communities and public trading groups. Pre-authorized users may view and search idle and surplus assets listed within the trading groups by category, keyword or attribute. Furthermore, the systems and methods may be integrated into the legacy systems and existing data structures of an entity.

### REFERENCE TO RELATED APPLICATIONS

The present application claims priority to, and incorporates by reference, co-pending U.S. patent application Ser. No. 60/269,128, entitled “Return on Asset Maximizer,” filed Feb. 15, 2001. The present application also claims the benefit of co-pending U.S. patent application Ser. No. 09/662,737, entitled “A System For Aggregating Information From Enterprises Offering Items For Exchange Over A Communication Network,” filed Sep. 15, 2000, and co-pending U.S. patent application Ser. No. 09/428,702, entitled “A System For Aggregating Information From Enterprises Offering Items For Exchange Over A Communication Network,” filed Oct. 27, 1999, both applications of which are hereby incorporated by reference.

### FIELD OF THE INVENTION

The present invention relates generally to systems and methods for managing assets and, more particularly, to systems and methods for increasing returns on assets.

### BACKGROUND

As corporations continue to face pressure to achieve more efficient operations, and with the global economy resulting in more expansion and consolidation, businesses are finding it difficult to manage capital assets, especially across divisions or geographies. These assets may come from a variety of activities, including mergers and acquisitions, equipment upgrades, and machinery recalls and replacements. Furthermore, companies typically lack an efficient mechanism for finding assets outside of their domain. This process can sometimes take weeks or months.

A scenario that occurs most frequently involves a company paying for asset disposal in one location while it unnecessarily purchases a similar asset in another location. This inefficiency is often due to the lack of an internal system that can efficiently aggregate and promote the availability of idle and surplus capital assets within and across an organization. In addition, because existing internal asset management systems typically do not integrate with purchasing and logistic systems, efficient redeployment of assets is challenging.

Some efforts have been made to increase the return on investment on assets. For example, many companies have established relationships with brokers who then take the assets and sell them to interested buyers. These brokers therefore act as a middle person between companies trying to obtain some value from their idle assets and groups of buyers who are seeking more cost effective solutions than buying assets new. A more recent approach in seeking a higher return on assets is reflected in many on-line auctions. The effect is very similar to the broker relationship in which buyers try to sell their idle or surplus assets through an auction site and buyers place bids for those assets in the on-line setting. In addition to on-line auctions, many companies have also joined business-to-business (BTB) exchanges in an effort to help reduce purchasing costs and streamline the procurement process.

These efforts at maximizing the return on investment on assets provide only limited success. These types of auctions and exchanges, as mentioned above, are in many ways an extension of the way these companies operated before, just implemented in the on-line environment. Companies may still fall into the trap of having paid for asset disposal in one location while purchasing similar assets in another location. These auctions and exchanges therefore do not optimize the ability of a company to maximize the return on its assets.

Other efforts in improving the return on assets have focused on tracking or monitoring the assets themselves. These efforts include enterprise asset management (EAM) systems which enable companies to tag assets, enter them into a repository, and track the usage of those assets. These types of EAM systems therefore enable companies to acquire an accurate inventory of its assets and also see a picture of which assets may be idle or surplus. Some of these EAM systems then partner with the on-line auctions or exchanges to help companies sell their idle and surplus assets. Again, as with the on-line auctions and exchanges, the EAM systems do not provide a solution whereby companies can efficiently redeploy assets within the organization itself.

Some of the efforts aimed at improving the return on assets do not offer practical solutions to companies. As mentioned above, many companies have long-standing relationships with brokers which may prevent the companies from forming new alliances with auctions or exchanges or which may at least be detrimental to the broker relationships. Some companies may therefore opt not to use the auctions or exchanges but instead honor the existing agreements with those brokers. Furthermore, some of the auctions and exchanges and other solutions provide additional overhead to the company. For example, these systems add an additional layer of complexity to monitor and control which assets are released or purchased. Furthermore, some of these systems are rather limited and do not offer much flexibility to the companies. For example, companies may be forced to sell their assets only through the solution provider's exchange, which may not have the best potential audience of buyers for certain assets.

In addition to efforts at increasing the value obtained from buying or selling assets, some efforts have also been made at redeploying assets within a company. With such a system, each region or division may fax or send e-mails describing idle and surplus assets to a centralized location. At the centralized location, these lists may then be published on that company's intranet. The cost of publishing these listings is rather high and typically offers very limited functionality to the users. For example, users typically have to exert great effort to find assets in these listings and further bureaucratic procedures in checking the internal listings as well as external sites and in making purchase requests, gathering the necessary approvals, and making an offer. In essence, many of these efforts at improving the internal redeployment of assets only offer a partial solution and, even at that, render it burdensome to the users.

### SUMMARY

The invention addresses the above stated problems by providing systems and methods for enabling entities to increase a return on assets. In a preferred embodiment of the invention, the systems and methods enable entities to pursue multiple avenues for increasing the value of the assets. One of these avenues is an internal trading community whereby idle or surplus assets within the entity can be redeployed elsewhere within that entity. Another one of these avenues is through a private trading community which enables an entity to maintain existing relationships with business partners, such as brokers, and which also enables entities to create new relationships with business partners, such as through auctions or business-to-business (BTB) exchanges. In addition to internal redeployment and private trading communities, the systems and methods also offer the ability to participate in public marketplaces. Thus, the systems and methods provide entities with the full range of options from internal redeployment, to interaction with private trading communities, to the public marketplace.

Preferably, the systems and methods integrate well within the entity thereby making the systems and methods user-friendly. For example, the systems and methods provide entities with control over which assets are listed and viewed, with this control at a granular level for the assets and also with control over who within the entity or outside of the entity can view those assets. The systems and methods also integrate with backend and legacy systems. The systems and methods provide workflows for listing the assets, such as to insure that the assets have been through an inspection process or review process, and also provides work flows for approving the purchase of assets whereby purchases are made only by authorized users and with the necessary approvals. The systems and methods also handle the transactional requirements of procurement, such as handling offers, purchase requests, transfers, bid management, RFQs and market listings. The systems and methods also provide useful tools for management whereby management can run reports, transactions, and analytics on overall operations.

The systems and methods also provide user-friendly tools in searching for assets. The systems and methods provide tools whereby users can search by category and sub-category, with the system and methods actively normalizing new listings to fit the existing categorization. Users can also search by keyword and can also establish search alerts whereby they will be alerted when assets fitting their criteria later become available. The system and methods therefore do not require the users to actively search the listings but instead can perform the necessary monitorings of the listings on behalf of the users. In all, the systems and methods integrate with existing inventory management, purchasing, and logistics systems and does not present a further layer of complexity on the users.

### BRIEF DESCRIPTION OF DRAWINGS

The accompanying drawings, which are incorporated in and form a part of the specification, illustrate preferred embodiments of the present invention and, together with the description, disclose the principles of the invention. In the drawings:

FIG. 1 is a block diagram of a network including an asset managing system according to an exemplary embodiment of the invention;

FIGS. 2(A) to 2(F) are screen shots illustrating examples of interfaces provided by an entity offering the exemplary invention;

FIG. 3 is a flow diagram illustrating the asset recovery workflow in the exemplary invention;

FIG. 4 is a screen shot illustrating the guided tour's description of the market overview of the exemplary invention;

FIG. 5 is a screen shot illustrating the guided tour's description of the environment of the exemplary invention;

FIG. 6(A) is a screen shot illustrating the guided tour's description of selling assets in the exemplary invention;

FIG. 6(B) is a process diagram of the tasks associated with the processes performed by an exemplary embodiment of the invention;

FIG. 7(A) is a screen shot illustrating the guided tour's description of listing assets privately in the exemplary invention;

FIG. 7(B) is a screen shot of an administrator interface for searching users in the exemplary invention;

FIG. 7(C) is a screen shot of an administrator interface for adding a user in the exemplary invention;

FIG. 7(D) is a screen shot of an administrator interface for adding bulk users in the exemplary invention;

FIG. 7(E) is a screen shot of a user interface for logging into the exemplary invention;

FIG. 8(A) is a screen shot illustrating the guided tour's description of listing assets publicly in the exemplary invention;

FIG. 8(B) is a screen shot of an administrator interface for searching sites in the exemplary invention;

FIG. 8(C) is a screen shot of an administrator interface for adding a site in the exemplary invention;

FIG. 8(D) is a screen shot of an administrator interface for adding bulk sites in the exemplary invention;

FIG. 8(E) is a screen shot of an administrator interface for managing trading groups in the exemplary invention;

FIG. 9 is a screen shot illustrating the guided tour's description of seller management in the exemplary invention;

FIG. 10 is a screen shot illustrating the guided tour's description of disposal of assets in the exemplary invention;

FIG. 11 is a screen shot illustrating the guided tour's description of acquiring assets in the exemplary invention;

FIG. 12(A) is a screen shot illustrating the guided tour's description of searching assets in the exemplary invention;

FIGS. 12(B) and 12(C) are screen shots of user interfaces for searching assets in the exemplary invention;

FIG. 13(A) is a screen shot illustrating the guided tour's description of search results in the exemplary invention;

FIG. 13(B) is a screen shot of a user interface of search results in the exemplary invention;

FIG. 14(A) is a screen shot illustrating the guided tour's description of providing details of an item in the exemplary invention;

FIG. 14(B) is a screen shot of a user interface for providing details of an item in the exemplary invention;

FIG. 15 is a screen shot illustrating the guided tour's description of tracking an item in the exemplary invention;

FIG. 16 is a screen shot illustrating the guided tour's description of quotes in the exemplary invention;

FIG. 17(A) is a screen shot illustrating the guided tour's description of approval workflow in the exemplary invention;

FIG. 17(B) is a flow diagram of actions taken for approval workflow in the exemplary invention;

FIG. 17(C) is a screen shot of a user interface for providing management of activities in the exemplary invention;

FIG. 17(D) is a screen shot of a user interface for providing management of activities in the exemplary invention;

FIG. 18(A) is a screen shot illustrating the guided tour's description of reporting and history in the exemplary invention;

FIG. 18(B) is a screen shot of a user interface for managing reports in the exemplary invention;

FIG. 19 is a screen shot illustrating the guided tour's description of the technology overview of the exemplary invention;

FIG. 20 is a block diagram of the system of the exemplary invention;

FIG. 21 is a logical block diagram of the architecture of the exemplary invention;

FIGS. 22(A) to 22(C) are block diagrams of the architecture of a system according to a preferred embodiment of the invention; and

FIG. 23 is a block diagram of alternative embodiments of the asset managing system of the exemplary invention.

### DETAILED DESCRIPTION

Reference will now be made in detail to preferred embodiments of the invention, non-limiting examples of which are illustrated in the accompanying drawings.

I. Overview

Systems and methods according to a preferred embodiment of the invention enable for the most optimal use of assets. According to one aspect, the systems and methods can help entities avoid unnecessary costs associated in acquiring assets when other assets suitable for their use may be redeployed. For example, rather than purchasing new capital assets, a company can find the same assets available elsewhere within the organization. The systems and methods are ideal for companies, especially large companies, but may be employed by a multitude of different types of entities, including but not limited to partnerships, franchises, joint ventures, agencies, associations, membership groups, etc.

These systems and methods according to the invention provide for a more efficient use of assets. The systems and methods allow entities to redeploy their idle and surplus assets, assist in the sale and disposal process, and provide the resources to easily locate and buy from an aggregation of idle and surplus assets.

According to one aspect of the invention, the systems and methods enable users to establish trading communities. These communities may include an internal trading community, such as one within the entity itself. Some examples of internal trading communities may be across divisions within a corporation or within a multi-national company. Another type of trading community is a private trading community which can be composed of ad hoc groups or groups having some relationship. Furthermore, the systems and methods enable the formation of public trading groups in which the public at large can trade assets with an entity. An entity preferably has control over which assets are listed on which exchange or trading group. For instance, an entity may first try to redeploy assets within the internal trading community, then try with a private trading community and then finally as a last resort list those assets in the public marketplace. An entity may therefore have different assets listed in the different trading groups.

In addition to listing assets, the systems and methods also enable the viewing and searching of those assets within the trading groups. The users preferably have a number of ways to search and view assets. These systems and methods also preferably enable members to purchase the assets and assist in the entire purchasing and procurement processes.

The systems and methods according to the invention may be implemented in a number of different ways. For example, the system may be operated by an entity which uses the system in redeploying assets. Alternatively, the system may be offered by an application service provider, a service bureau, an outsourcing entity, or on a distributed network.

II. System Level

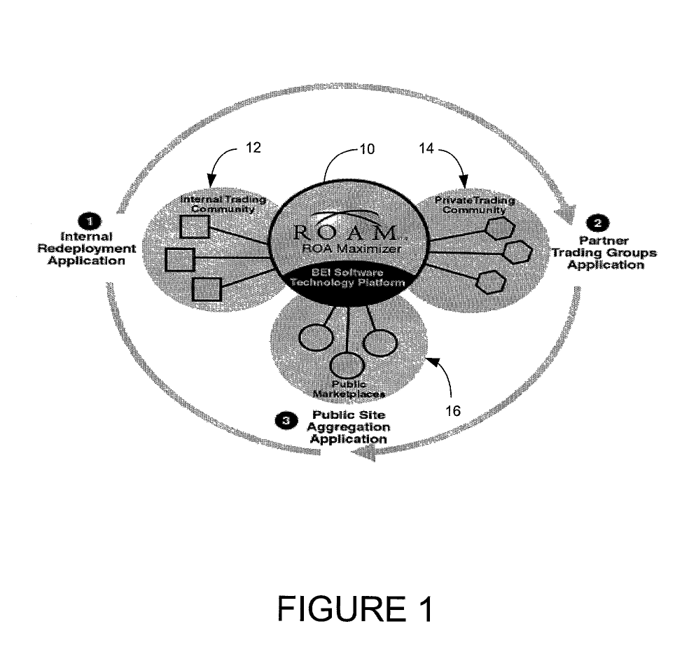

An asset managing system 10 according to a preferred embodiment of the invention will now be described with reference to FIG. 1. As shown in this diagram, the asset managing system 10 can define an internal trading community 12, a private trading community 14, or a public marketplace 16. As mentioned above, the internal trading community 12 may be used for internal redeployment of assets, such as across divisions or across geographical areas. The private trading community 14 is beneficial for partner trading groups and may be used instead of or in addition to the internal trading community 12. The public marketplace 16 places even fewer restrictions on users and in fact may be a public site. A logical progression for either the purchase or sale of assets is to begin with the internal trading community 12 and then go to the private trading community and then finally the public marketplace 16.

As shown in FIG. 1, the asset managing system is termed ROAM, which is an acronym for Return On Asset Maximizer. This name for the system 10 was provided by BEI Software but it should be understood that the software may have other names and that other entities may sell, license, distribute, or otherwise use the system 10. For example, the system 10 may be associated with the name Rivant Assets and be operated by a company Namisoft, Inc. For the purposes of this description, the system 10 will be associated with the ROAM name and the BEI Software Company.

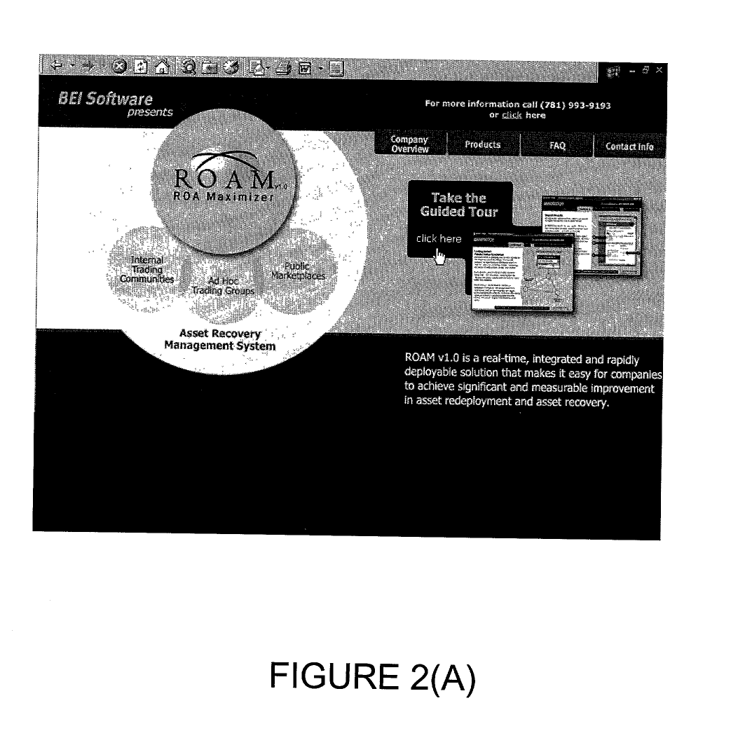

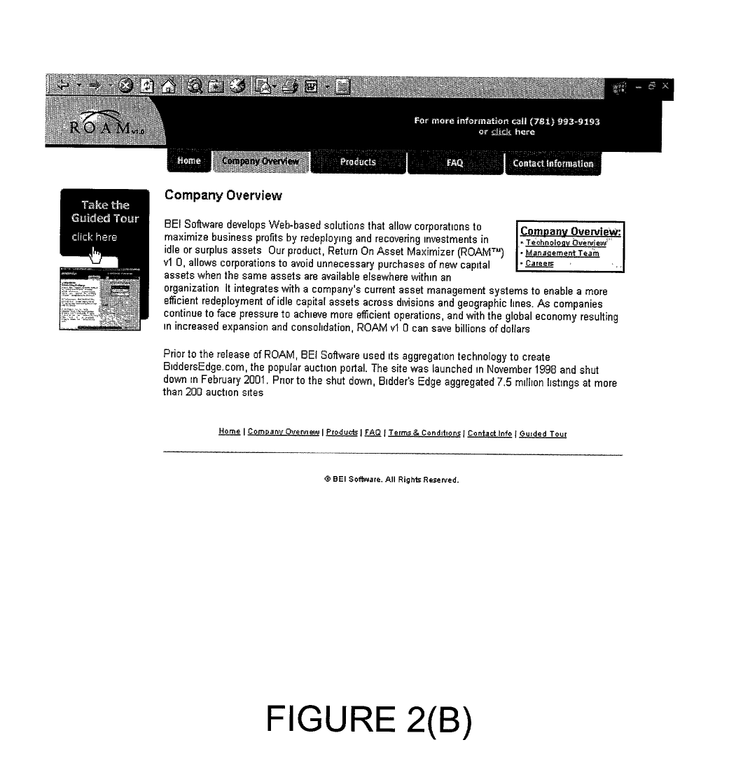

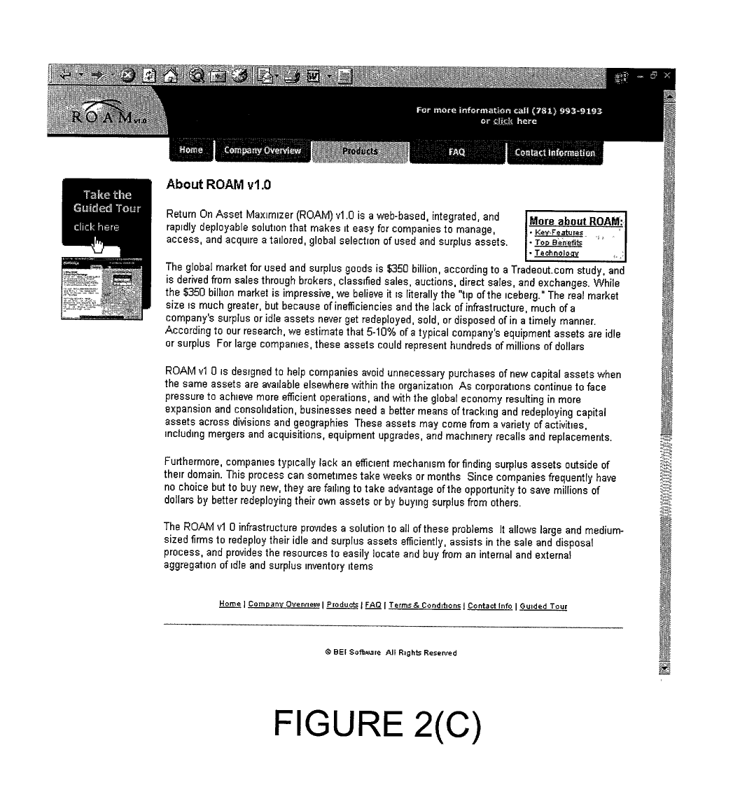

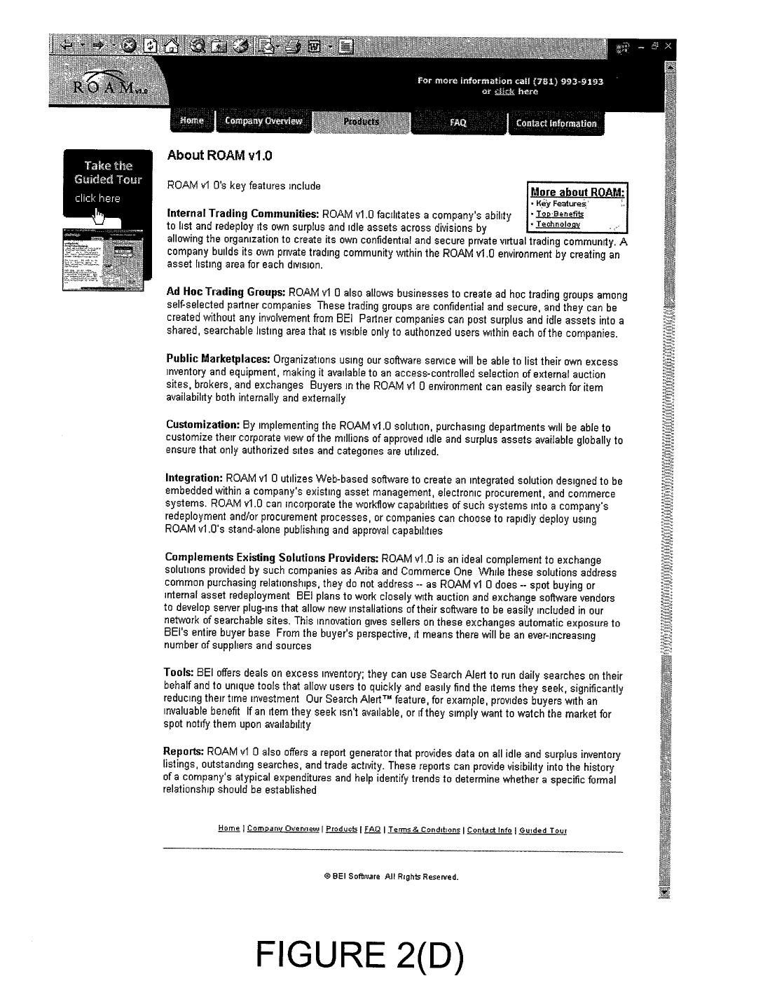

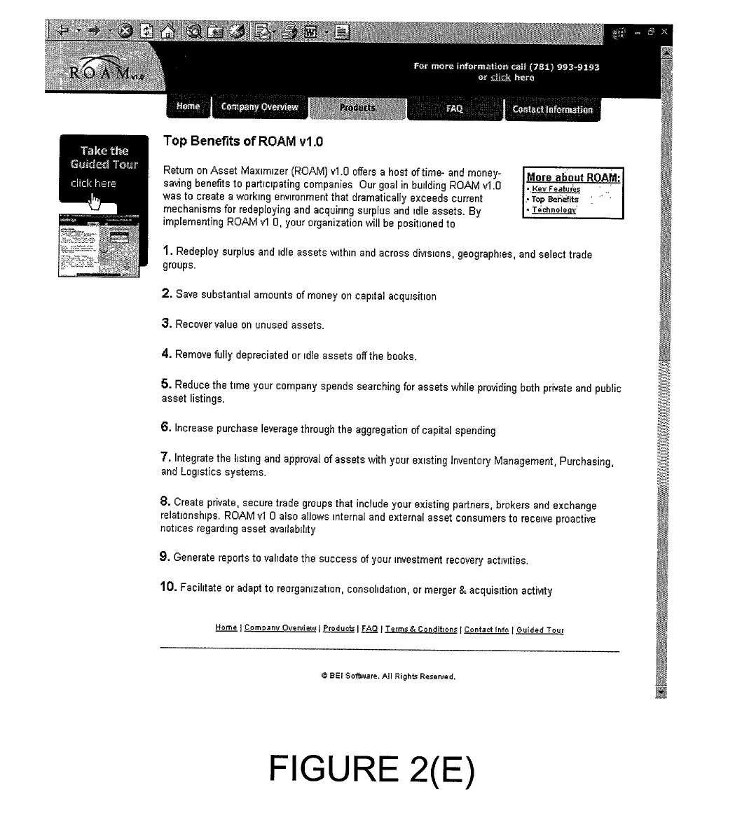

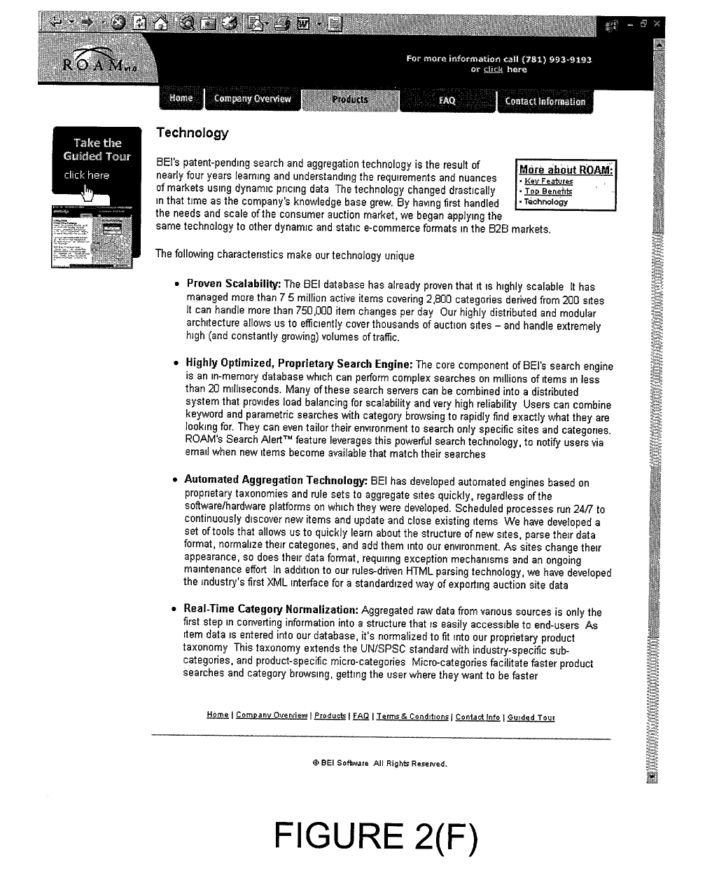

FIGS. 2(A) to 2(F) are exemplary interfaces provided by an entity offering the asset managing system 10. As shown in FIG. 2(A), a visitor to this site can take a guided tour of the asset managing system 10, which will be described below with references 4 to 19. Also, as shown in this figure, the ROAM asset managing system can operate with internal trading communities, ad hoc trading groups, and public marketplaces. FIG. 2(B) provides an overview of the company and FIGS. 2(C) to 2(E) provide a summary of the asset managing system, its features, and benefits. For example, the description in FIG. 2(C) notes that an estimated five to ten percent of a typical company's equipment assets are idle or surplus and explains that the asset managing system 10 allows large and medium sized firms to redeploy their idle and surplus assets efficiently, assist in the sale and disposal process, and provides the resources to easily locate and buy from an internal and external aggregation of idle and surplus inventory items. FIG. 2(D) provides some of the key features of the asset managing system 10 according to a preferred embodiment of the invention. These features include the different trading groups which include an internal trading community, an ad hoc trading group, and a public marketplace. Also, this interface explains how the asset managing system 10 can be customized by purchasing departments to insure that only authorized sites and categories are utilized and how the asset managing system 10 is integrated with a company's existing asset management, electronic procurement, and commerce systems. This figure also explains how the asset managing system 10 compliments existing solutions providers, such as auction and exchange software vendors, offers unique search tools, and offers a report generator to provide greater visibility into a company's assets. Some of the key benefits of the asset managing system 10, as mentioned in FIG. 2(E), include the ability of the asset managing system 10 to redeploy surplus and idle assets, thereby saving substantial amounts of money and recovering the value on unused assets. Fully depreciated or idle assets can be removed from the books, a company can reduce the amount of time spent searching for assets, and the company can increase purchase leverage through the aggregation of capital spending. Furthermore, the asset management system integrates with existing inventory management, purchasing, and logistics systems, creates private, secure trade groups, has report generating functionality, and facilitates or adapts to reorganization, consolidation, or merger and acquisition activity.

FIG. 2(F) provides a brief overview of some of the technology incorporated into the asset management system 10. The first characteristic mentioned is scalability which is due in part to a highly distributed and modular architecture which can efficiently cover thousands of auction sites and high volumes of traffic. The asset management system 10 also has a highly optimized search engine which can perform complex searches on millions of items in less than 20 milliseconds. The search capability provides keyword and parametric searches with category browsing and also has a search alert feature to notify users via e-mail when new items become available that match their searches. A suitable search engine for providing this functionality is provided in co-pending U.S. patent application Ser. No. 60/269,128 entitled “Return On Asset Maximizer,” filed Feb. 15, 2001, and U.S. patent application Ser. No. 09/662,737, entitled “A System for Aggregating Information From Enterprises Offering Items for Exchange Over a Communication Network,” filed Sep. 15, 2000, and U.S. patent application Ser. No. 09/428,702, entitled “A System for Aggregating Information From Enterprises Offering Items for Exchange over a Communication Network,” filed Oct. 27, 1999, which are incorporated herein by reference. Another unique characteristic of the asset management system 10 is automated aggregation technology comprising automated engines to aggregate sites quickly. These engines provide tools that quickly learn about the structure of new sites, parse the data format, normalize their categories, and add them into the asset management system 10. Another new characteristic of the asset management system 10 is real-time category normalization. The normalization unit takes aggregated raw data and normalizes it to fit a proprietary product taxonomy having industry specific sub-categories, and product-specific micro-categories.

III. Workflow

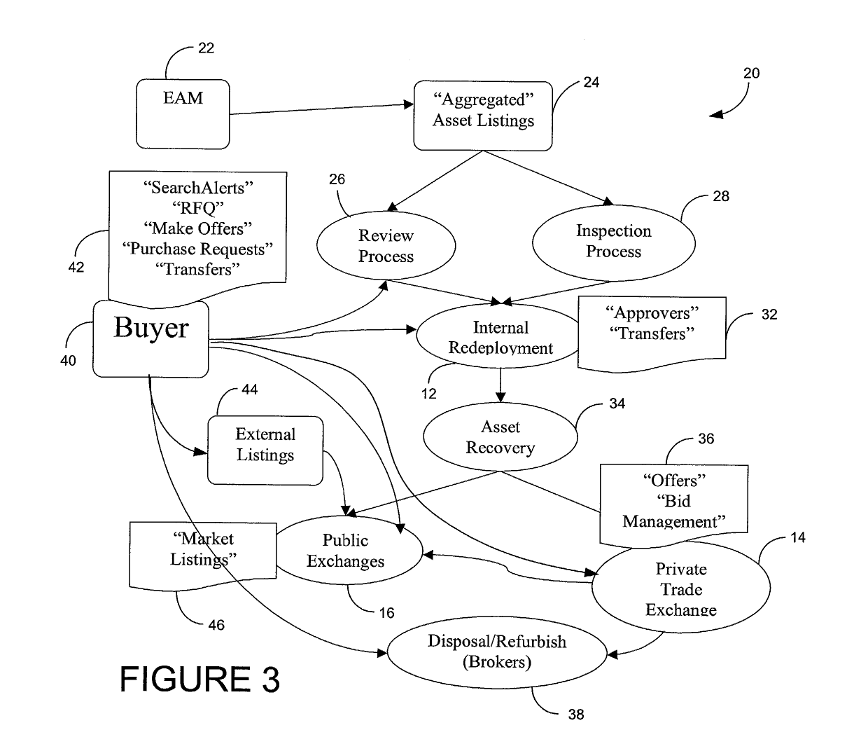

An asset recovery workflow 20 according to a preferred method of the invention will now be described with reference to FIG. 3. The workflow 20 begins with taking data from an existing asset manager (EAM) 22 to form aggregated asset listing at 24. The EAM 22 may comprise any existing conventional system for tracking the inventory and assets of a company. Also, the EAM 22 may comprise consultants or other entities that take surveys of companies assets which then allow for the aggregated asset listings at 24. The EAM 22 may also form part of the asset management system 10. After the aggregated asset listings at 24 have been prepared, the workflow 20 then proceeds to a review process 26 and an inspection process 28. The review process 26 involves a determination as to which assets are idle or can be redeployed. The inspection process 28 results in a determination as to which of those assets are not suitable for reuse or redeployment. The results of the review process 26 and the inspection process 28 is the formation of a list of assets that are suitable for internal redeployment at 12. At 12, the assets are then listed within the internal trading group or community 12 and at 32 the lister can entertain transfer requests and initiate an approval process.

If the assets are not redeployed internally through the internal trading group 12, then the workflow 20 proceeds to an asset recovery process at 34 where the assets may be moved to the private trading exchange or community at 14 or the public exchange or marketplace at 16. For the public exchanger 16, the assets can be placed on market listings 46 and for the private trading exchange 14 the assets may be the subject of offers and bid management at 36.

A buyer 40 can potentially buy assets through the internal redeployment at 12, through a private trading exchange at 14 or through the public exchange at 16. For the internal redeployment at 12, the buyer 40 may participate in the review process 26. The buyer can also review external listings 44 available through the public exchanges 16 or go through a third party, such as a disposal or refurbish broker 38 and access the private trading exchange 14. The buyer 40 has a number of tools at its disposal. These tools include search alerts 42 whereby the buyer 40 can be alerted to assets that meet certain defined criteria. The buyer can also issue a request for quotation (“RFQ”), make offers, make purchase requests, or request transfers through the tools 42.

The asset recovery workflow 20 shown in FIG. 3 is an example of how assets may become more efficiently used, either internally or externally. The workflow 20 begins with aggregated asset listings 24 which contains information on the assets that are idle or can be more efficiently used elsewhere. These assets are then targeted for internal redeployment at 12, offered in a private trading exchange 14, or are placed on external listings 44 at a public exchange 16. The asset recovery workflow 20 accommodates buyers in all types of trading groups, regardless of whether the buyer 42 can redeploy the asset internally, participates directly or indirectly in a private trading group, or purchases the assets through a public exchange 16. The asset recovery workflow accommodates all aspects of the purchase and procurement processes, including offering, bid management, approval processes, etc. Additional features and benefits of the workflow 20 will become apparent from the description below of a preferred implementation of an asset management system 10.

IV. User Interfaces

As mentioned above, the exemplary interfaces of references 2(A) to 2(F) offers a visitor to the site an opportunity to take a guided tour of the asset managing system 10. Each page of the guided tour has navigation buttons that allow the visitor to move between the pages of the tour. More importantly, the guided tour provides the visitor with information regarding the key features, benefits and uses of the asset managing system 10.

A. Market

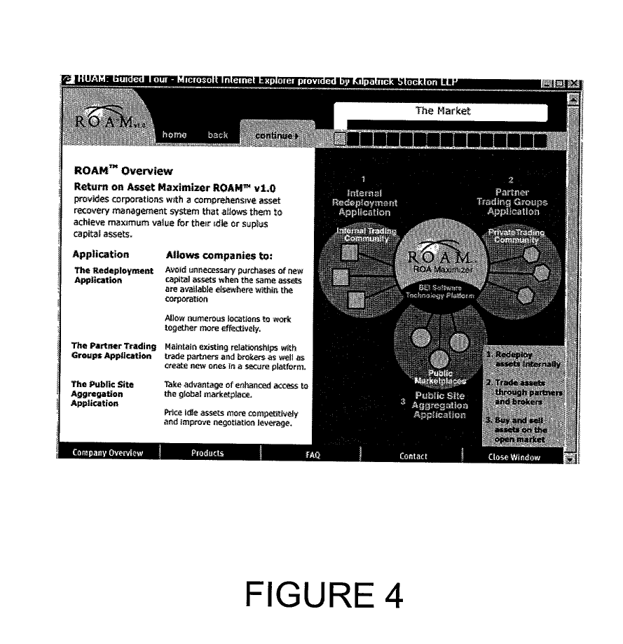

A screen shot of the first page of the guided tour according to a preferred embodiment of the invention will now be described with reference to FIG. 4. As shown in this screen shot, the guided tour provides a description of the market overview of the asset managing system 10. The market overview includes an explanation of the applications provided by the asset managing system 10 as well as a description of the benefits of the applications. For example, the public site aggregation application allows the user to price idle assets more competitively and improve negotiation leverage.

B. Environment Overview

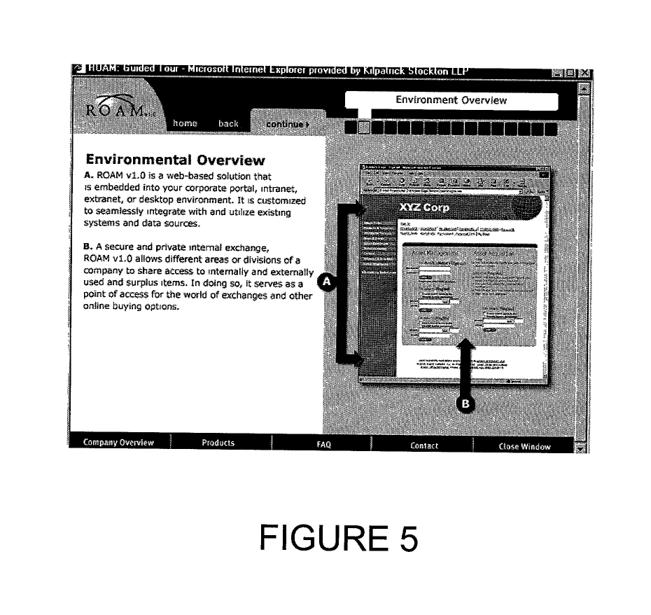

The second page of the guided tour according to a preferred embodiment of the invention will now be described with reference to FIG. 5. This page provides an overview of the environment of the asset managing system 10. The asset management system 10 may be embedded into a corporate portal, intranet, extranet, or desktop environment. Furthermore, the asset management system 10 may be customized to integrate with existing corporate systems and data sources. The environmental overview further instructs visitors that a preferred embodiment of the invention provides a secure and private point of access for purchasing and redeploying idle and surplus items.

C. Selling Assets

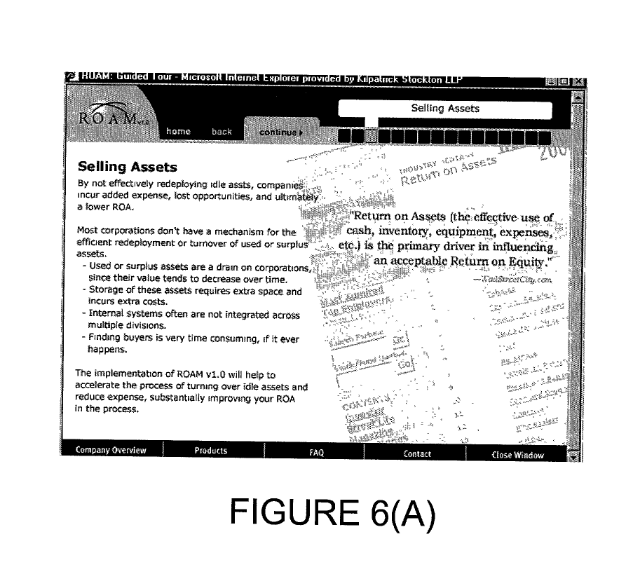

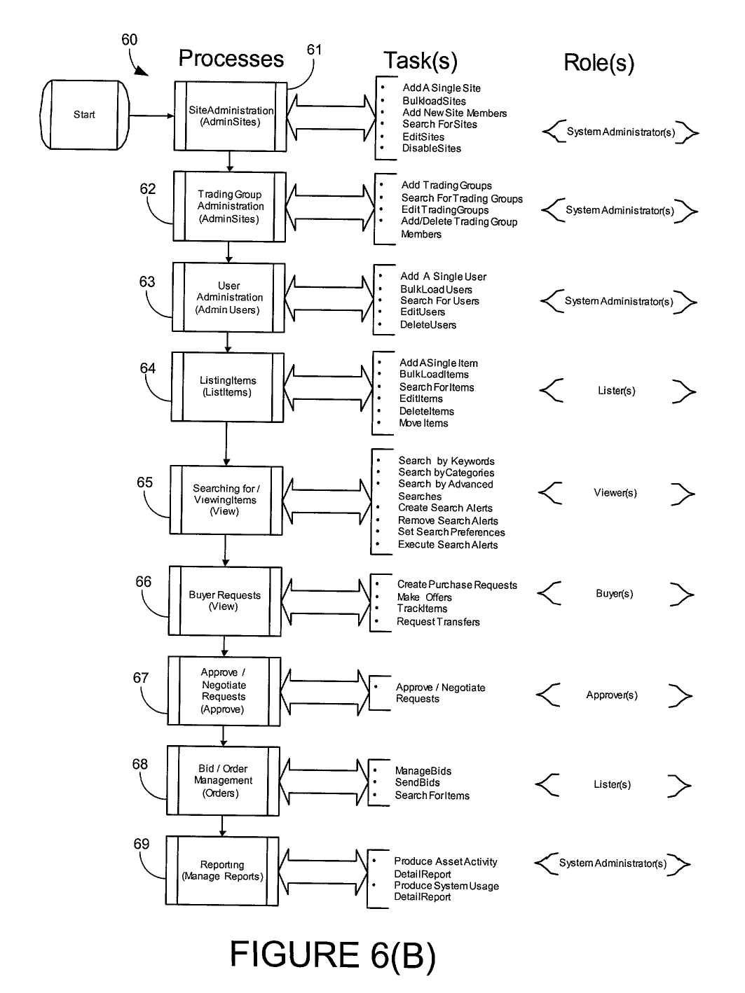

The guided tour's explanation of selling assets according to a preferred embodiment of the invention will be described with reference to FIG. 6(A). This page of the guided tour provides numerous drawbacks associated with companies not effectively redeploying idle assets. One such drawback is that the storage of idle assets requires extra space and incurs extra costs. A visitor of this page is notified that a preferred embodiment of the invention may assist in accelerating the process of distributing idle assets, which may in turn reduce expenses.

A process diagram of the tasks associated with the processes performed by a preferred embodiment of the invention will be described with reference to FIG. 6(B). The process diagram 60 illustrates the sequence of actions in the processes of a preferred embodiment of the invention along with the associated tasks and the associated role of the user.

The first process in the sequence of the exemplary embodiment of the invention is Site Administration 61. The tasks associated with Site Administration 61 may be preformed by the system administrator and may include adding a single site, adding bulk sites, adding new site members, searching sites, editing sites and disabling sites.

The next process in the sequence, Trading Group Administration 62, may also be performed by the system administrator. The tasks associated with Trading Group Administration may include, among other things, adding, searching, editing and disabling Trading Groups.

Trading Group Administration 62 may be followed by the User Administration 63 process. During the User Administration process 63, the system administrator of the asset managing system 10 may manage the potential and actual authorized users. The tasks associated with User Administration 63 are similar to the tasks carried out by the Site Administration 61. The tasks of the User Administration may include adding a single user, adding bulk users, searching users, editing users, disabling users and managing user groups.

The process of Listing Items 64 may be the next process. In the Listing Items 64 process, a lister or listers may manage idle or surplus items by adding a single item, bulk load items, searching for items, editing items, deleting or moving items.

The next process in the process diagram 60 is the Finding Items 65 process. The Finding Items 65 process provides viewers the ability to locate idle or surplus assets for redeployment. The tasks associated with the Finding Items 65 process may include searching by keywords, searching by categories or category browsing, searching by advanced searches, creating search alerts, removing search alerts and setting search preferences.

The Items Request 66 process may follow the Finding Items 65 process. This process allows buyer utilizing the asset managing system 10 to bid on idle or surplus assets. The tasks associated with the Items Request 66 process may include creating purchase requests, making offers and tracking items.

The next process, Request Approvals and Request Negotiations 67, may be performed by the approvers. The tasks that may be performed by the approvers during the Request Approvals and Request Negotiations 67 process may include approving offer requests and negotiating offer requests. This process will be examined in greater detail in reference 17(B).

The Item Management 68 process provides listers with the ability to remove redeployed items from consideration by buyers. In a preferred embodiment of the invention listers may update the list of idle and surplus items by deleting approved items during The Items Management 68 process.

The final process in the exemplary embodiment of the invention is the Reporting 69 process. The reports created during the Reporting 69 may be generated by the system administrator. The tasks associated with the Reporting 69 process may include producing reports, managing approved items and managing items that are awaiting approval.

In any given run of the sequence of the process diagram 60, one or more process or task may be omitted or repeated. Moreover, several processes with in the same run may be performed out of sequence. For example, the task of adding a single user associated with the User Administration 63 process may be performed prior to a task associated with the Trading Group Administration 62 process.

D. Listing Assets Privately

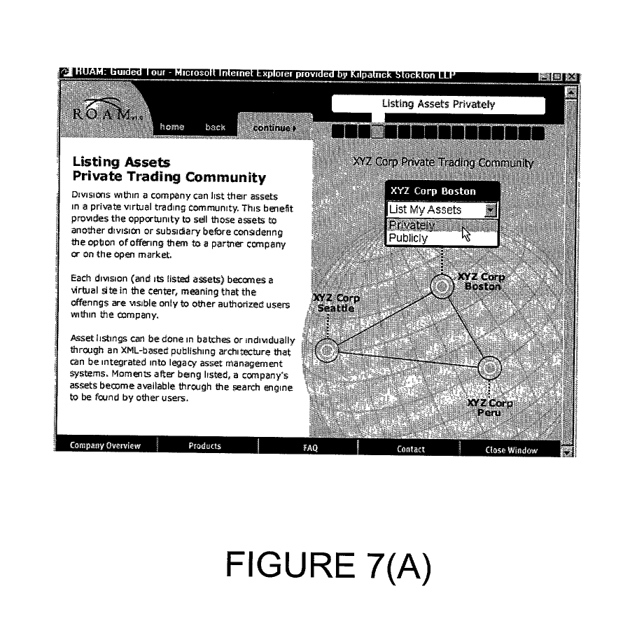

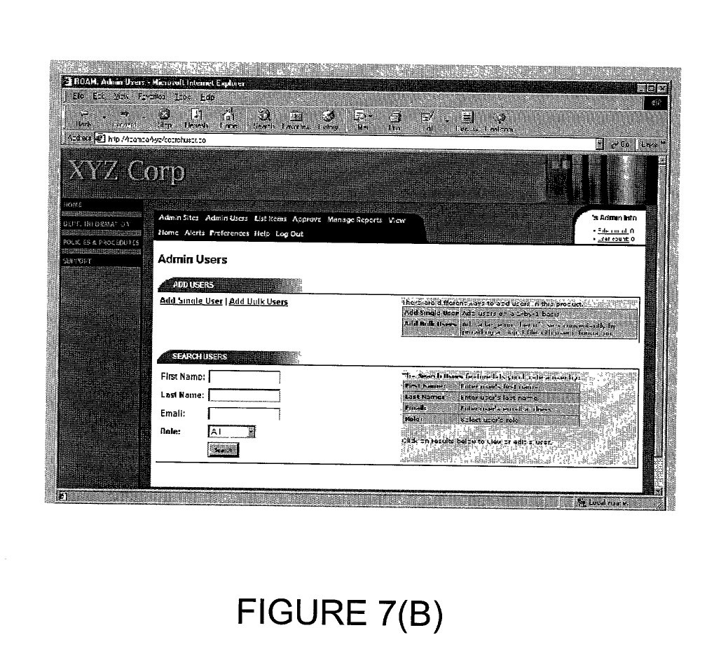

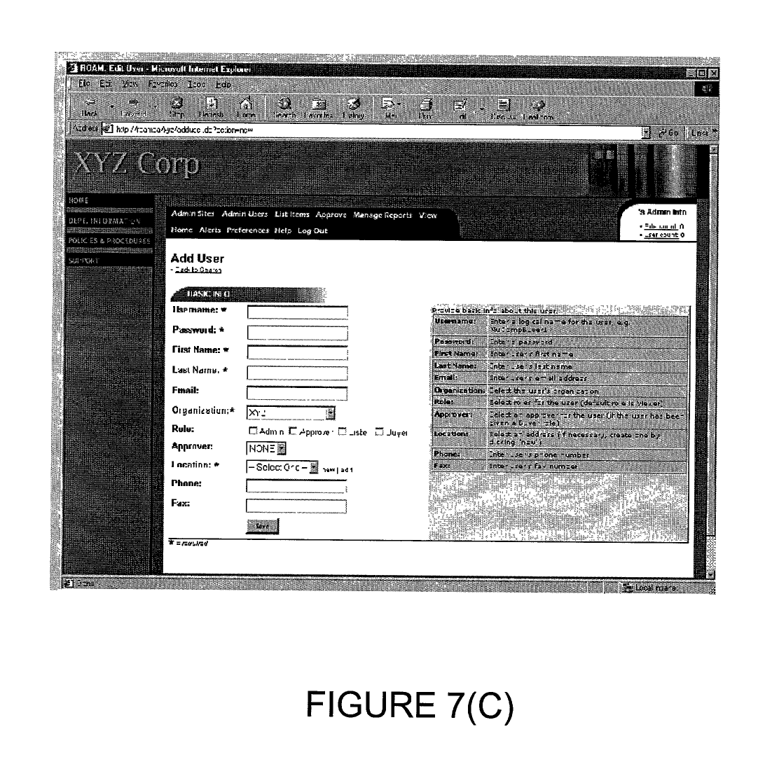

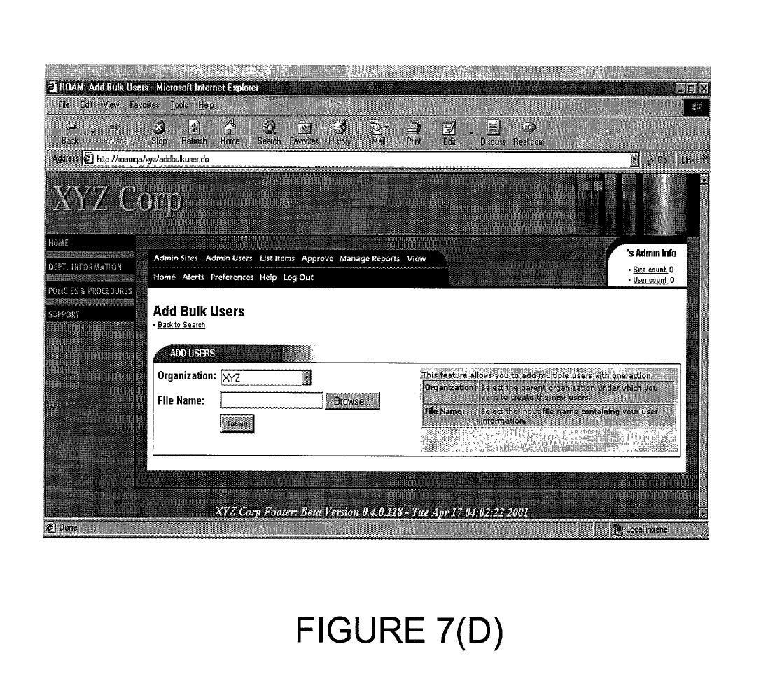

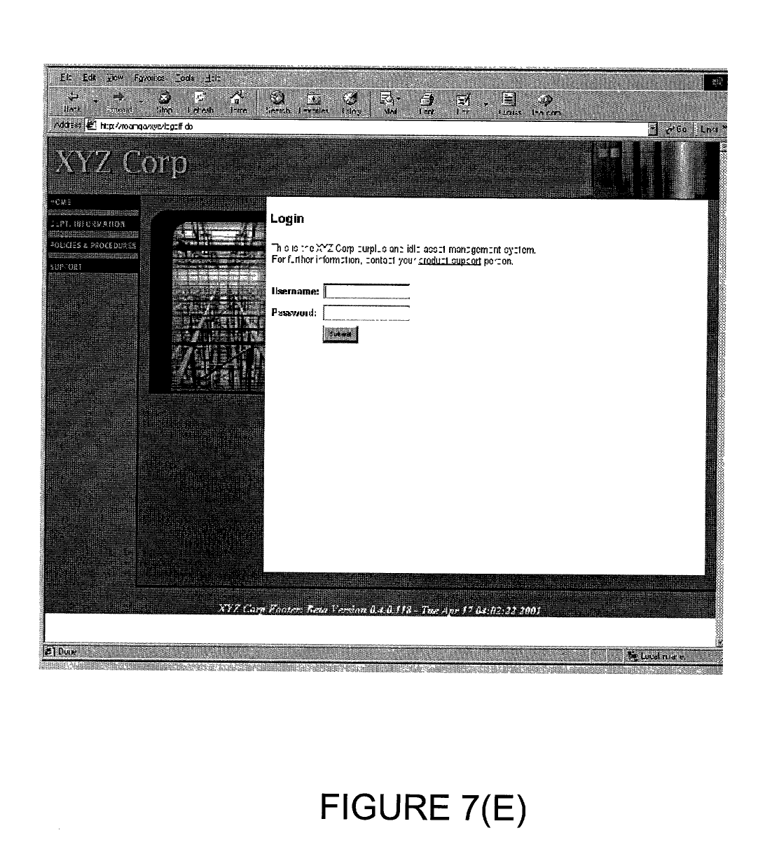

Yet another page of the guided tour will now be described with reference to FIG. 7(A). This guided tour page provides a description of listing assets within a private trading community. Listing assets within a private trading community provides an opportunity to distribute idle or surplus assets to another division or subsidiary before offering the items to a partner company or the public at large. In the private trading community, only authorized users may view the listed assets. Moreover, assets may be listed individually or in bulk by integrating an XML-based publishing architecture into the legacy asset managements systems.

FIG. 7(B) is a screen shot of an administrator interface for searching for users in a preferred embodiment of the invention. In this screen, the administrator may add a single user, add bulk users, or search for users. An administrator may search for users by entering information into the input fields provided by the asset managing system 10. The input fields may include first name, last name, and email address. The screen of FIG. 7(B) may also include a drop down menu for selecting the role of the user.

FIG. 7(C) is a screen shot of an administrator interface for adding a single user in a preferred embodiment of the invention. This screen may include input fields for entering information regarding the user to be added. For example, the fields may include user name, password, first name, last name, email address, the user's role, telephone number, and facsimile number. The screen may also have drop down menus for the organization of the user, pre-assigning an approver to the user and the location of the user.

A screen shot for adding bulk users in a preferred embodiment of the invention is illustrated in the FIG. 7(D). The screen allows the administrator to add multiple users to the list of authorized users with one action. The screen for adding bulk users may comprise a drop down menu for selecting the organization of the new users as well as an input field for the name of the file containing the list of users.

Once a user has been added by the administrator, the user may log into the asset managing system 10. The login screen as illustrated in the screen shot of FIG. 7(E). The login screen may include input fields for entering the authorized users' user name and password.

E. Listing Assets Publicly

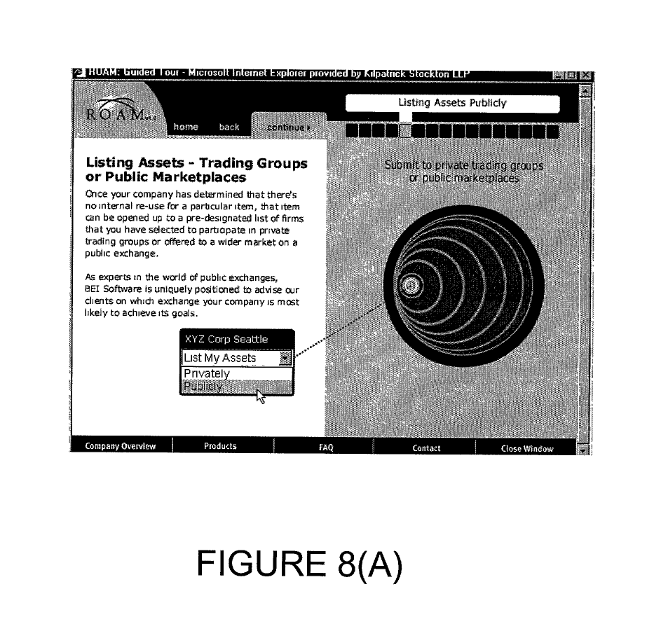

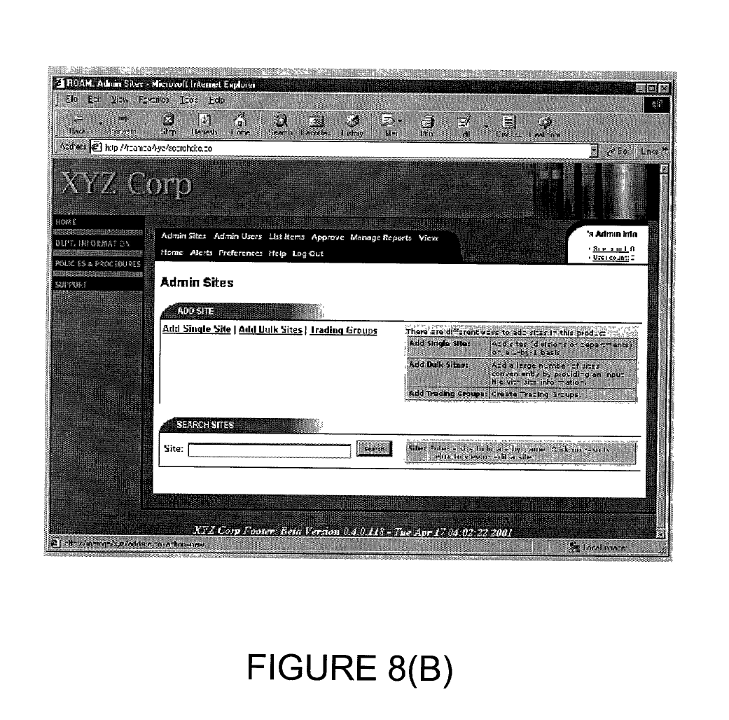

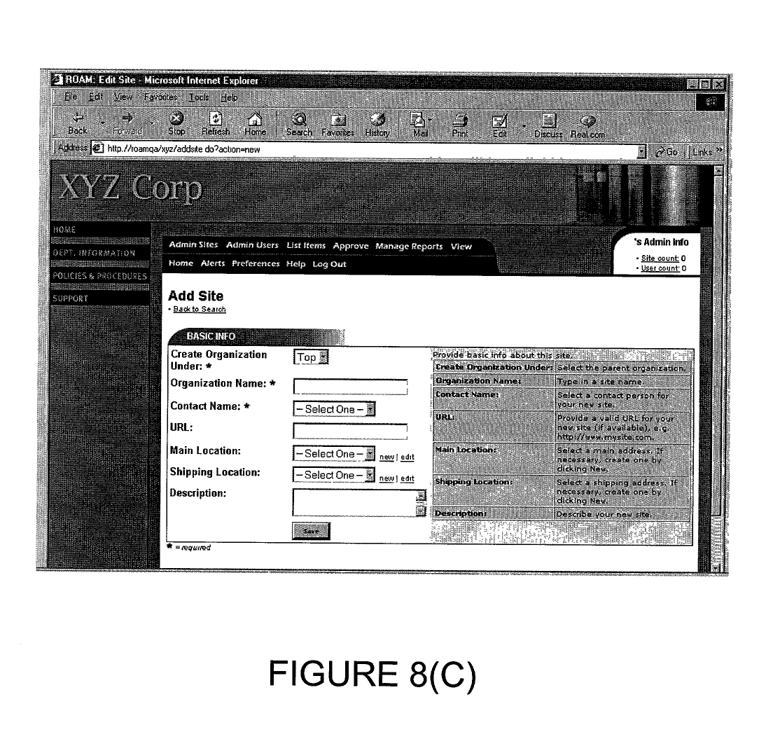

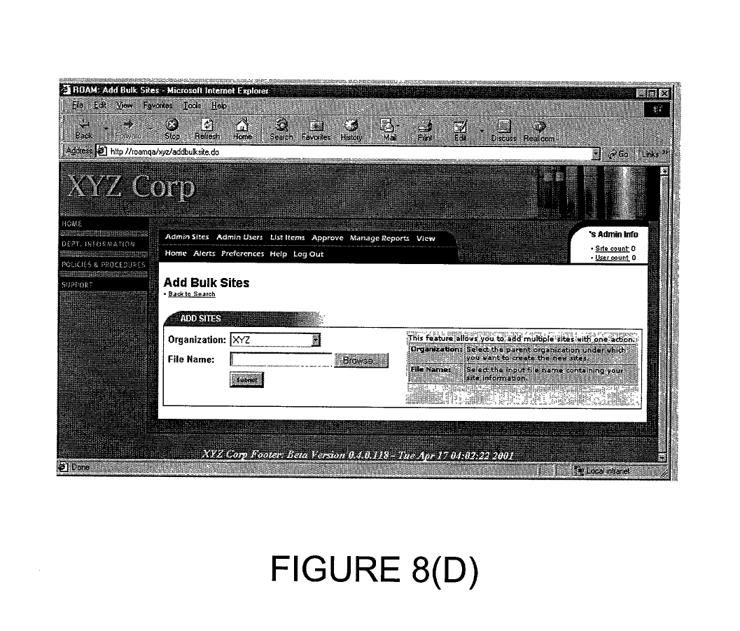

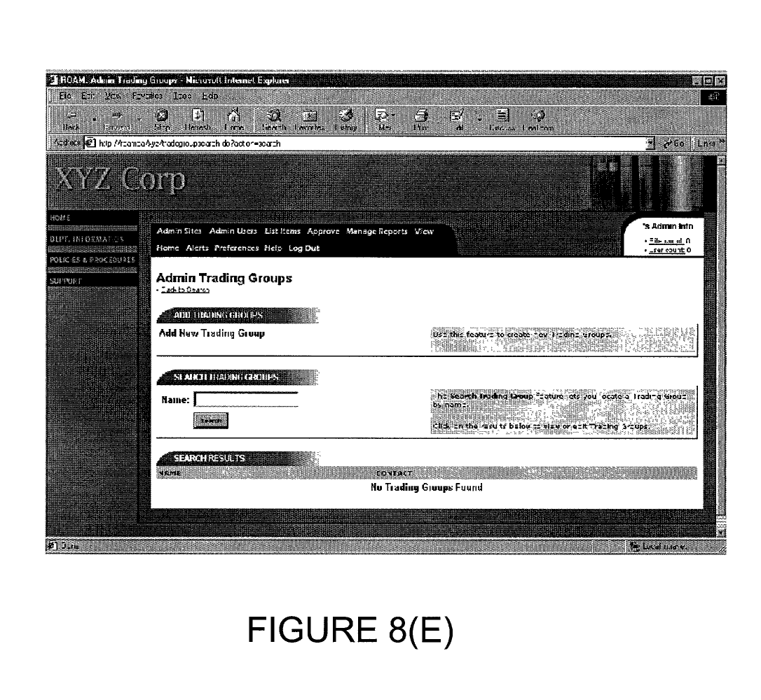

Assets may also be listed in private trading group or public market places as illustrated in a preferred embodiment of the invention in FIG. 8(A). After attempting to redeploy the idle or surplus assets internally, the user may attempt to distribute idle or surplus assets to groups having some relation to the user prior to offering the items to the public at large. If unsuccessful, the company may choose to list the assets in a public marketplace. The screen shot of FIG. 8(A) further comprises an example of a drop down menu that may be used to select whether to list the assets of the company privately or publicly.

FIG. 8(B) illustrates a screen shot of an administrator interface for adding and searching sites to the public marketplace in a preferred embodiment to the invention. The screen of FIG. 8(B) may include an input field for entering the site for which the administrator is searching. This screen may also include links that allow the administrator to add a single site, add bulk sites, or add and search trading groups.

FIG. 8(C) is a screen shot of an administrator interface for adding a site in a preferred embodiment of the invention. The administrator may enter various information regarding the site that is being added. FIG. 8(C) may include input fields for the site name, the site location (“URL”) and a description of the site. This screen may also include several drop down menus including, but not limited to selecting the parent organization of the site selecting the main address of the site as well as the shipping address of the site.

FIG. 8(D) illustrates a screen shot of an administrator interface for adding bulk sites in a preferred embodiment of the invention. This screen allows the administrator to add multiple sites with one action. The screen of FIG. 8(D) may include a drop down menu for selecting the parent organization of the new sites as well as an input field for entering the name of the file containing the bulk site information.

The administrator may also add and search private trading groups. As discussed above, the trading groups may include business partners of the company utilizing a preferred embodiment of the invention. As illustrated in a preferred embodiment of the invention in FIG. 8(E), the screen for administering trading groups may include a link for adding a new trading group as well as an input field for entering the name of a trading group to be searched.

F. Seller Management

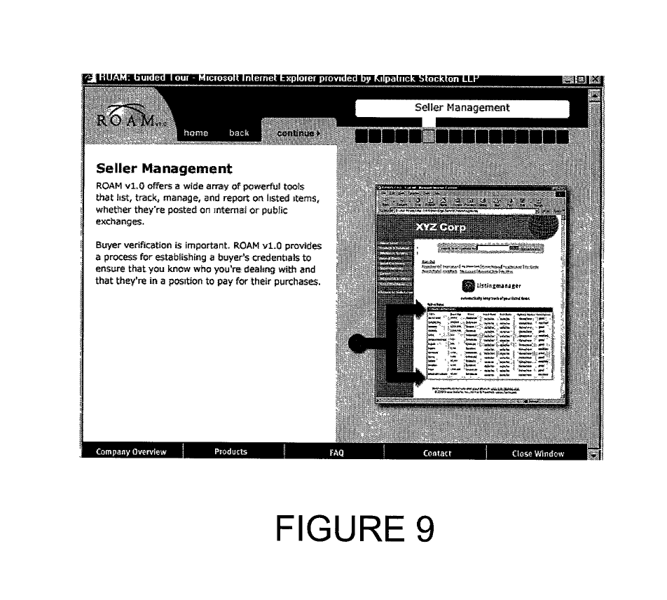

A preferred embodiment of the invention may also provide management of the sellers of listed assets. As illustrated in FIG. 9, a preferred embodiment of the invention may include a process for establishing a buyers credential prior to accepting that purchasers offer. FIG. 9 may also include information regarding the management of listed items in a preferred embodiment of the invention.

G. Disposal

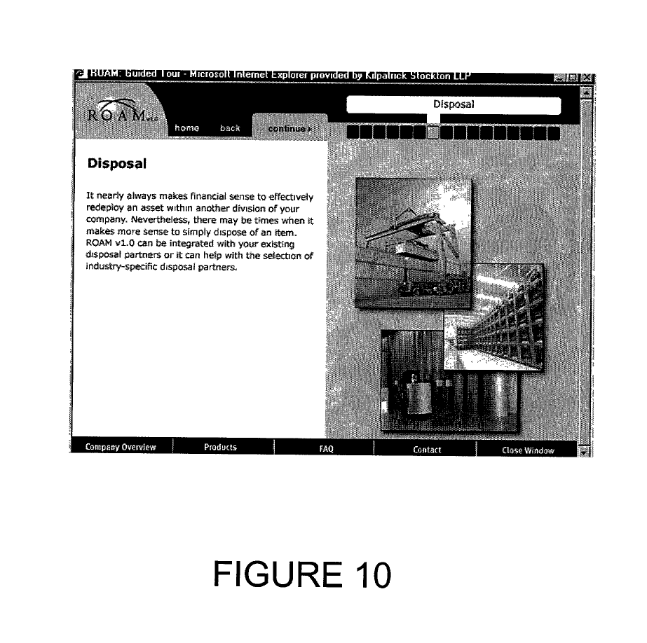

Disposal of idle and surplus assets according to a preferred embodiment of the invention will now be described with reference to FIG. 10. This screen of guided tour may provide information regarding the exemplary inventions ability to integrate with a company's existing disposal partners. For example, the asset managing system 10 may be integrated with existing disposal partners.

H. Acquiring Assets

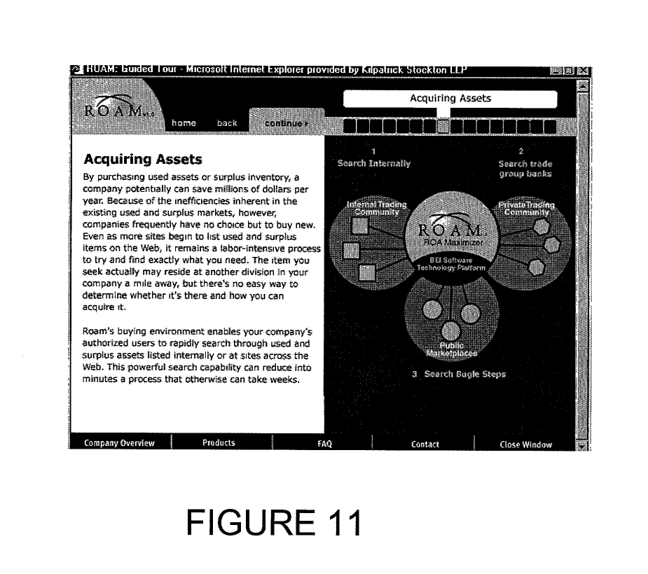

Acquiring assets according to a preferred embodiment of the invention will now be discussed with reference to FIG. 11. This guided tour may include information describing the ability of the asset managing system 10 to search for idle assets listed internally. The screen of may also describe the ability of the asset managing system 10 to search for assets listed at public sites on the Internet.

I. Searching for Assets

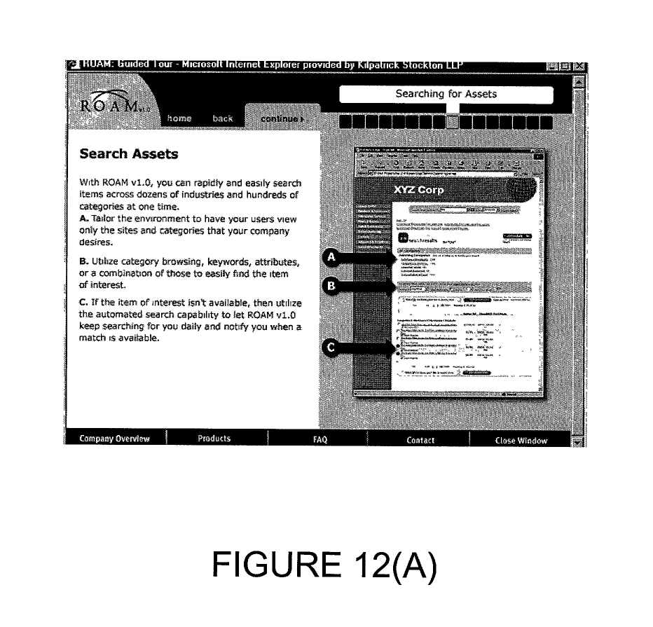

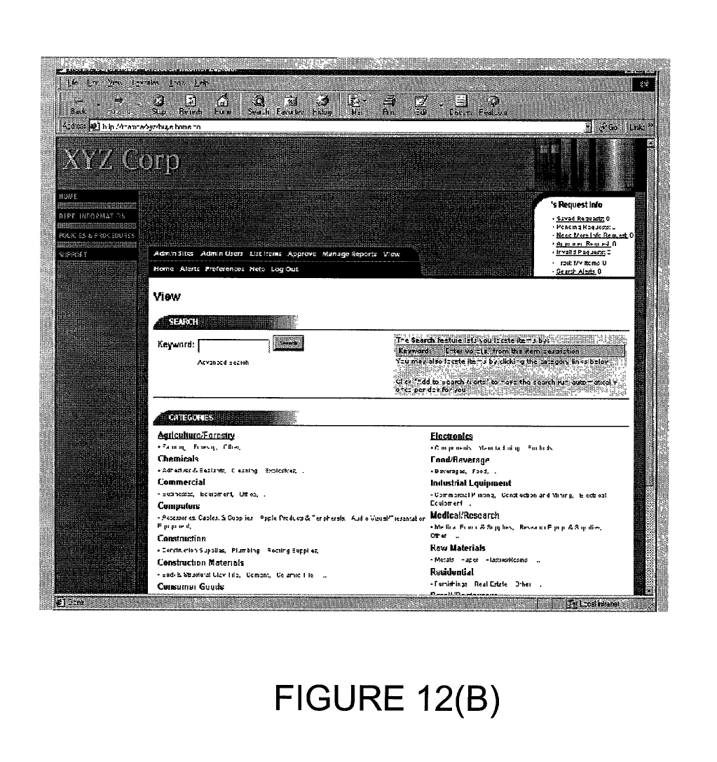

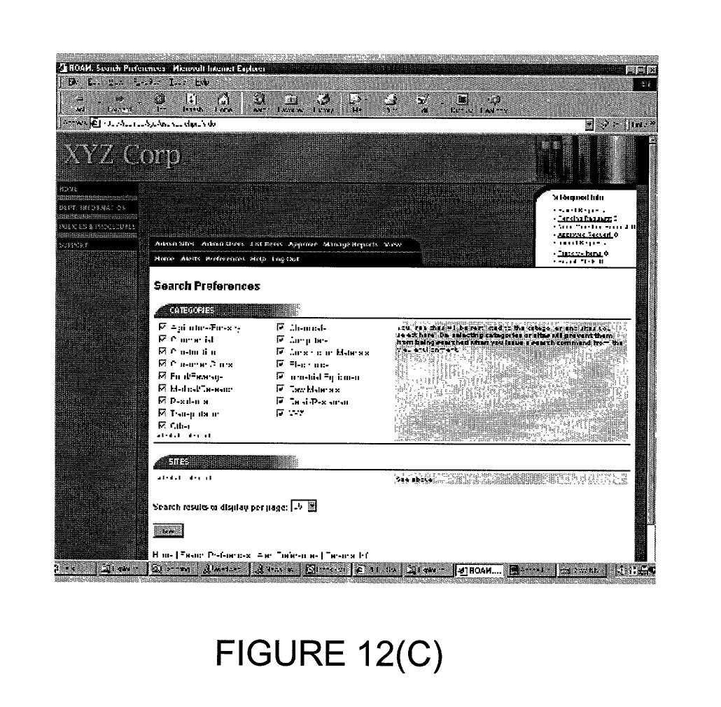

The guided tour's description of searching for assets in a preferred embodiment of the invention is illustrated in the screen shot of FIG. 12(A). A user may search by category or a key word. Moreover, the user may search more than one category at a time. The screen of FIG. 12(A) may also describe other advantages of searching for assets using the asset managing system 10. For example, the screen may describe the ability of the asset managing system 10 to automatically search for items of interest and notify the user when the item is located.

FIG. 12(B) illustrates a screen shot of a user interface for searching for assets in a preferred embodiment of the invention. This screen may include an input field for entering a key word to perform a keyword search. Furthermore, this screen may include a listing of categories that may be search.

FIG. 12(C) illustrates another embodiment of a user interface for searching for assets in the exemplary invention. In this embodiment of the search screen, the categories may be listed next to boxes that allow the user to select or deselect a single or multiple categories.

J. Search Results

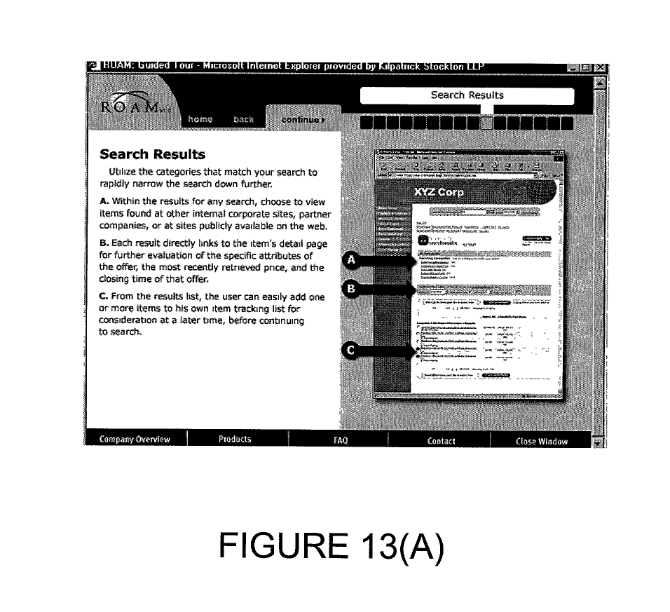

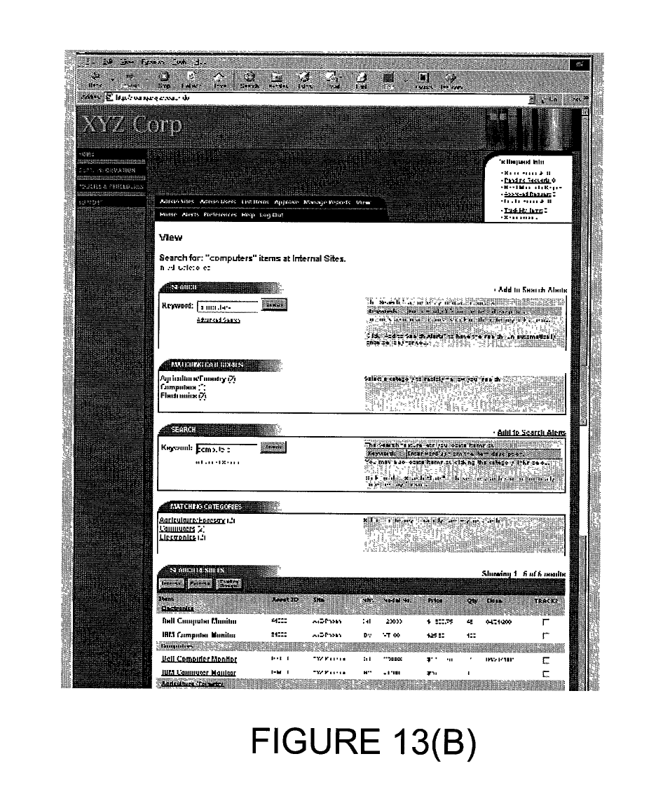

FIG. 13(A) is a screen shot illustrating the guided tour's description of search results in a preferred embodiment of the invention. This screen includes information regarding the users' ability to view detailed information regarding the items found during the search. Moreover, the user may include one or more items on a tracking list, allowing the user to view the details of the item at a later time.

FIG. 13(B) is a screen shot of a user interface illustrating the search results in the preferred embodiment of the invention. The search results screen may include input fields for conducting additional searches. The screen of FIG. 13(B) may also include a list of items located during the prior search. Selecting any of the listed items allows the user to view detailed information regarding that particular item.

K. Item Detail

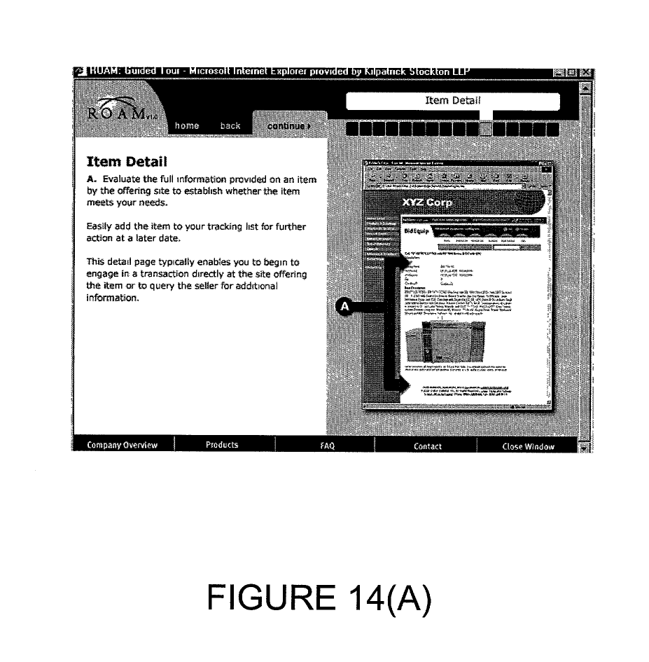

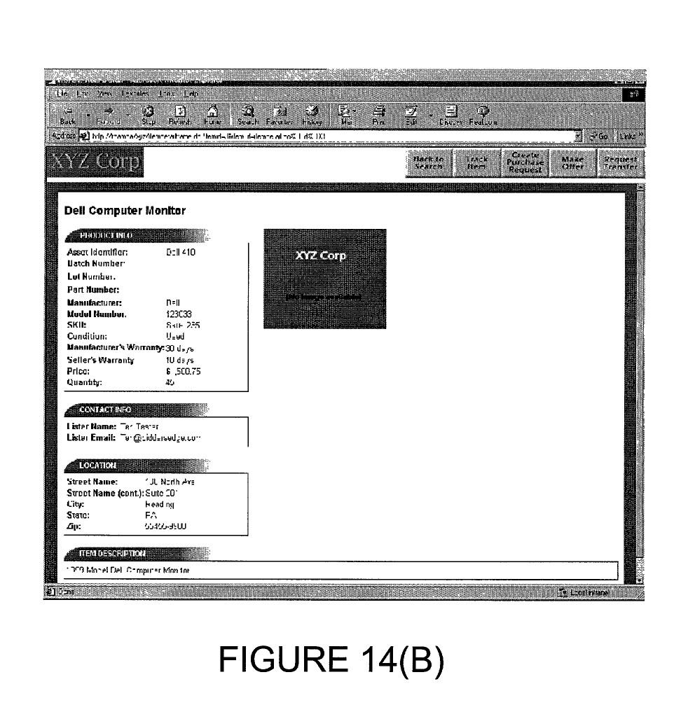

The item detail page of the guided tour according to a preferred embodiment of the invention will now be described with reference to FIG. 14(A). This page may include information regarding the user's ability view detailed information regarding the idle or surplus item as well as the user's ability to add the item to a tracking list for viewing at a later date. Moreover, the screen may include information regarding the ability of the user to engage in a transaction directly from the item detail screen in the asset managing system 10.

FIG. 14(B) is a screen shot of the user interface for providing details of an item to a user in a preferred embodiment of the invention. The screen of FIG. 14(B) may include product information regarding the item as well as the contact information of the seller. For example, the product information may include the manufacturer, model number, and selling price of the item.

L. Item Tracking

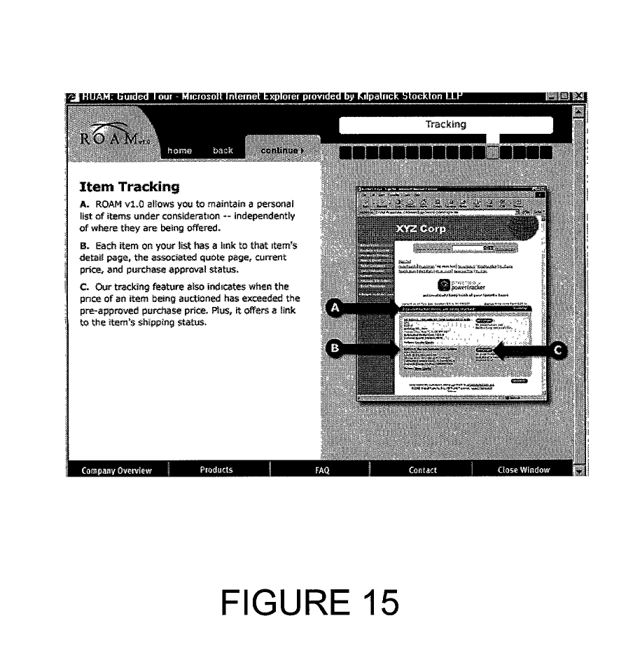

FIG. 15 is a screen shot illustrating the a page in the guided tour describing the tracking an item in a preferred embodiment of the invention. By adding items to a tracking list, the user may maintain a personal list of items under consideration. The items on the tracking list may include a link to that item's detailed page, the associated quote page, current price, and purchase approval status. Moreover, this page may describe the ability of the asset managing system 10 to indicate when a price of an item has exceeded the pre-approved purchase price.

M. Quotes

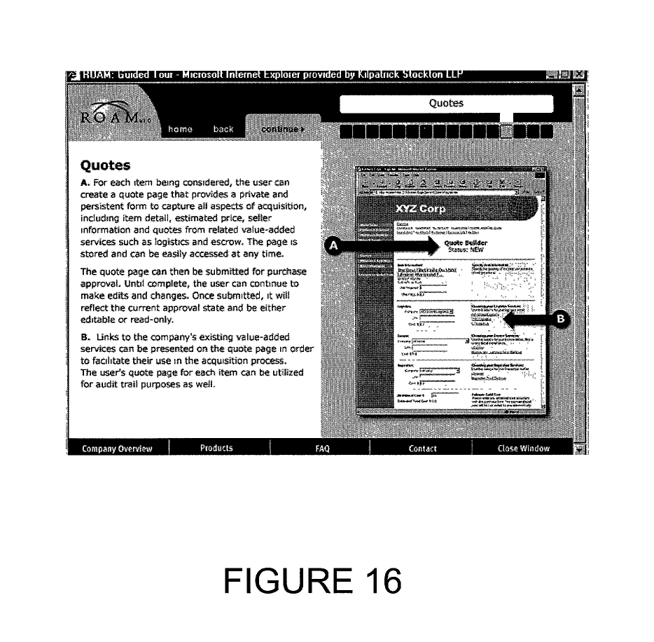

FIG. 16 is a screen shot illustrating the page in the guided tour describing the creation and maintenance of a quote in the exemplary invention. This screen may explain that the user can create a quote page that provides one form that captures all aspects of the item acquisition. For example, the form may include item detail, estimated price, seller information, and quotes from related value-added services. Furthermore, the quote page may be edited and submitted for purchase approval. This screen may also include information regarding a company's ability to provide the links on the quote page to the company's existing value-added services. Additionally, the user's quote page for each item may be utilized as an audit trail.

N. Approval Workflow

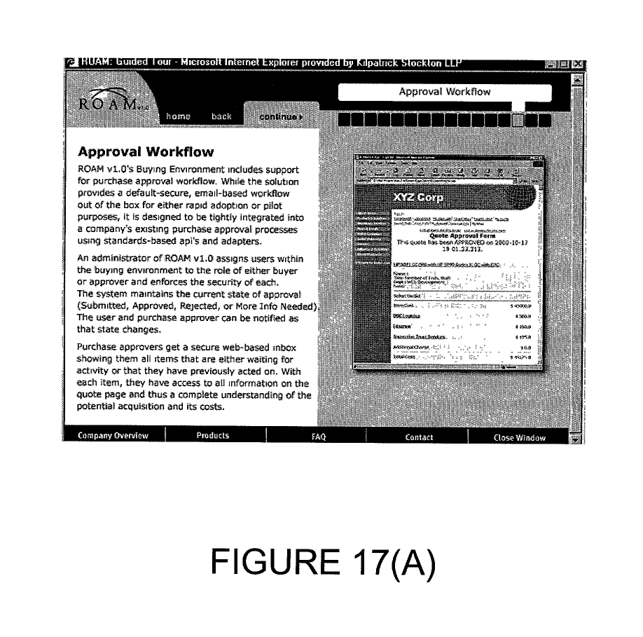

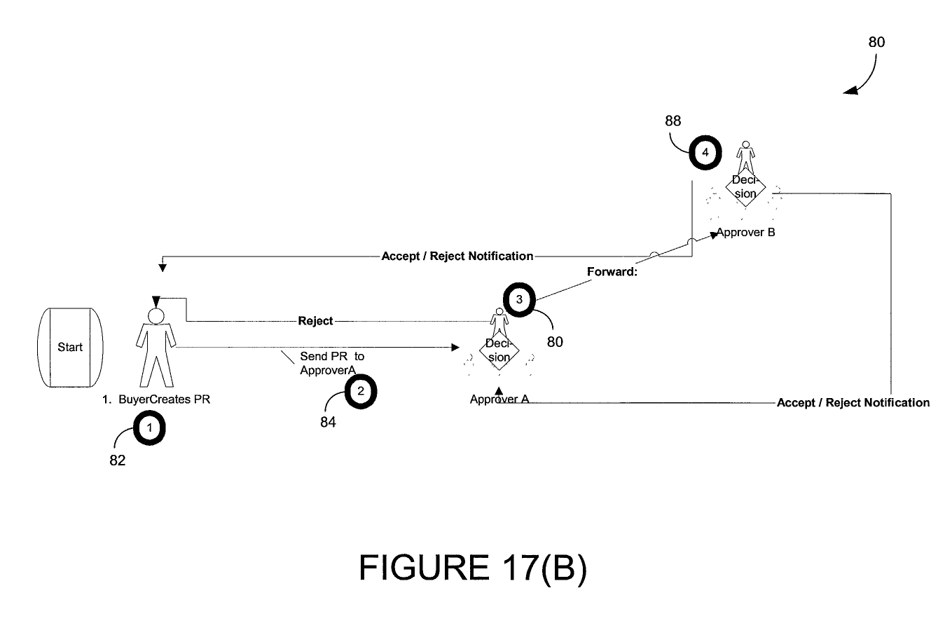

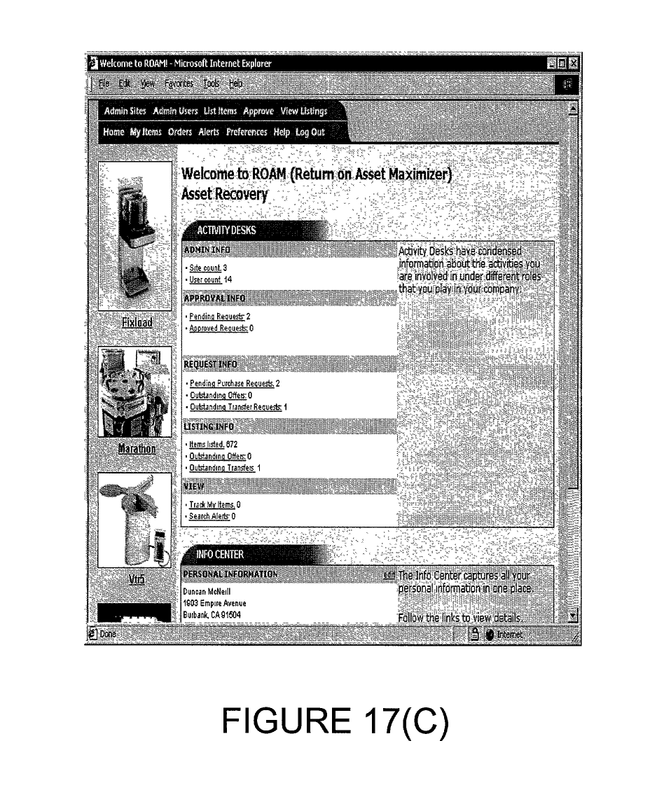

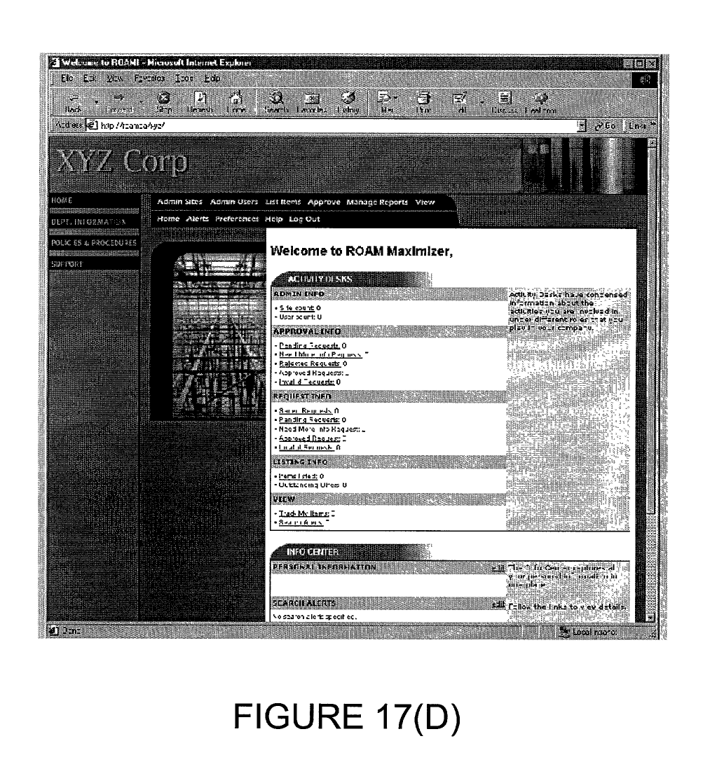

A guided tour page describing approval workflow according to the preferred embodiment of the invention will now be described with reference to FIG. 17(A). This page may provide information regarding the exemplary invention's ability to be integrated into a company's existing purchase approval processes. A preferred embodiment of the asset management system 10 may use standards based API's and adaptors. The page of FIG. 17(A) may provide information regarding the exemplary invention's ability to maintain the current state of approval of each listed item as well as the ability to notify a user or purchaser if the state of approval changes. This screen may also provide information regarding a purchase approver's ability to view items that are waiting for approval as well as items that have been previously approved or rejected.

FIG. 17(B) is a flow diagram of the approval workflow in a preferred embodiment of the invention. The approval workflow Flow Diagram 80 begins when the buyer creates a Purchase Request 82. In action 84, the purchase request is submitted to Approver A. In action 86, Approver A makes a determination as to whether to reject the purchase request or to forward the purchase request to Approver B. If the purchase request is rejected, the buyer is notified of the rejection. Alternatively, if the purchase request is forwarded to Approver B, Approver B may make a determination as to whether reject the purchase request or accept the purchase request, action 88. After accepting or rejecting the purchase request, Approver B notifies both the buyer and Approver A of the decision. In an alternative embodiment of the invention, an approver may return the purchase request to the buyer to solicit additional information prior to making a determination.

FIG. 17(C) is a screen shot of a user interface for providing management of activities in a preferred embodiment of the invention. The screen of FIG. 17(C) may allow the user to view information regarding his or her authorized user account. The screen may include information regarding the activities and roles of the user. For example, the screen of FIG. 17(C) may include information, approval information regarding pending requests, purchase request information, item listing information, information on tracked items as well as the user's personal information. FIG. 17(D) is an alternative embodiment of the screen shown in FIG. 17(C).

O. Reporting and History

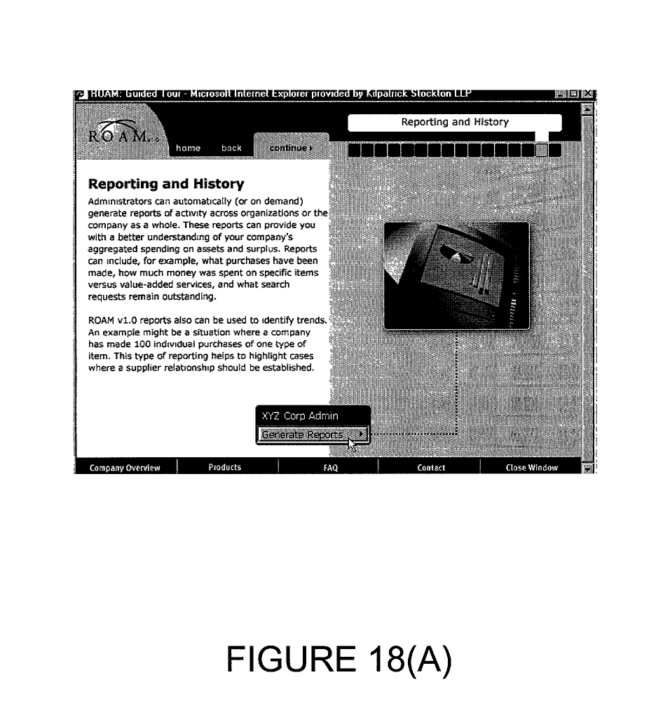

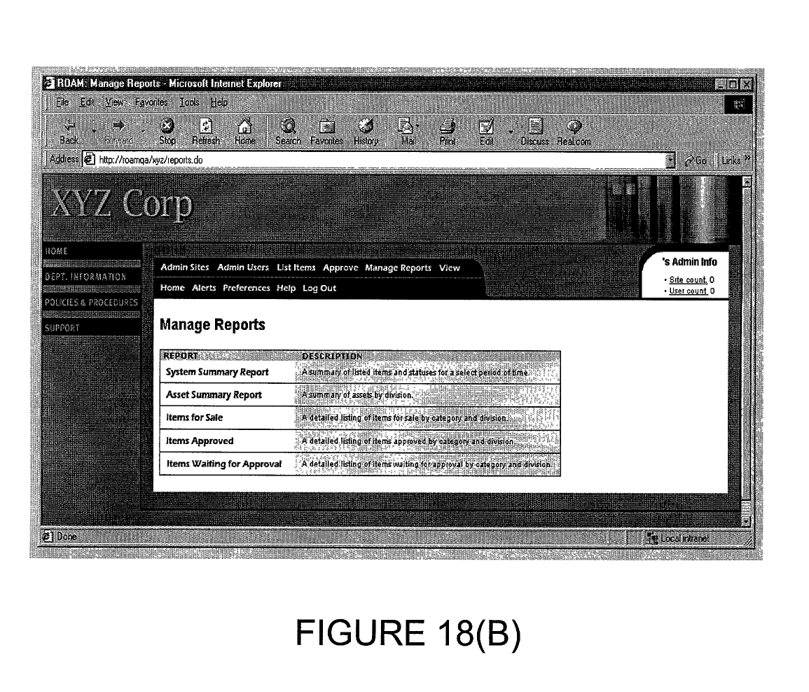

FIG. 18(A) is a screen shot illustrating a page in the guided tour describing the reporting and history according to a preferred embodiment of the invention. Administrators may automatically generate reports of activity across organizations or the company as a whole. The reports may include information regarding the company's purchases, idle assets, and requests that remain outstanding. Moreover, this page of the guided tour may provide information regarding the ability of the asset managing system 10 to provide reports that may be used to identify purchasing and distribution trends.

A screen shot of a user interface for managing reports in a preferred embodiment of the invention is illustrated in FIG. 18(B). This screen may provide the administrator with the ability to review and generate reports on activity across organizations or the company as a whole. For example, the administrator may generate a system summary report that provides a summary of listed items as well as the status of the listed items. The administrator may also create and view reports regarding asset summary, items for sale, approved items, and items waiting for approval. Furthermore, the reports generated by the administrator may be sorted by category.

P. Technology Overview

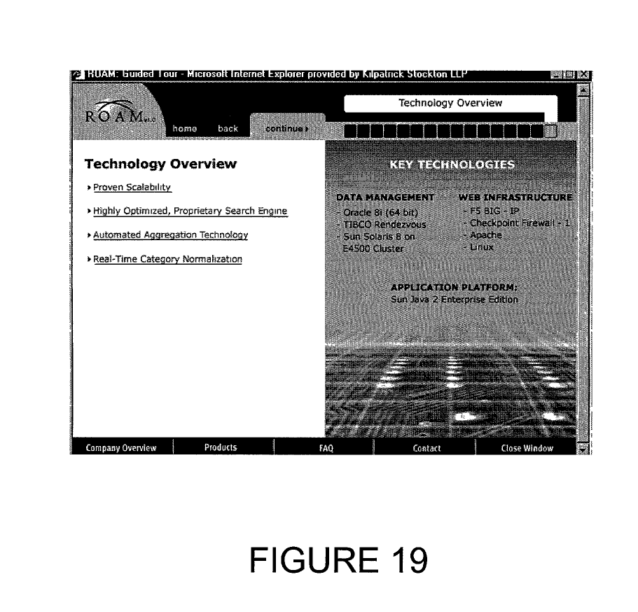

The guided tour page describing the technology overview according to a preferred embodiment of the invention will now be described with reference to FIG. 19. This page of the guided tour provides information regarding the key features of the asset managing system 10 as well as the key technologies involved in a preferred embodiment of the invention. For example, proven scalability, highly optimized, proprietary search engine, automated aggregation technology, and real-time category normalization may be listed as the key features of the asset managing system 10. As a further example, Oracle 8i (64 bit), TIBCO Rendezvous, Sun Solaris 8 on E4500 Cluster may be listed as key technologies related to data management. Key technologies related to web infrastructure that may be listed include, but are not limited to, F5 BIG-IP, Checkpoint Firewall-1, Apache and Linux. Additionally, Sun Java 2 Enterprise Edition may be listed as the key technology related to the application platform.

V. System Diagrams

(A) Architecture

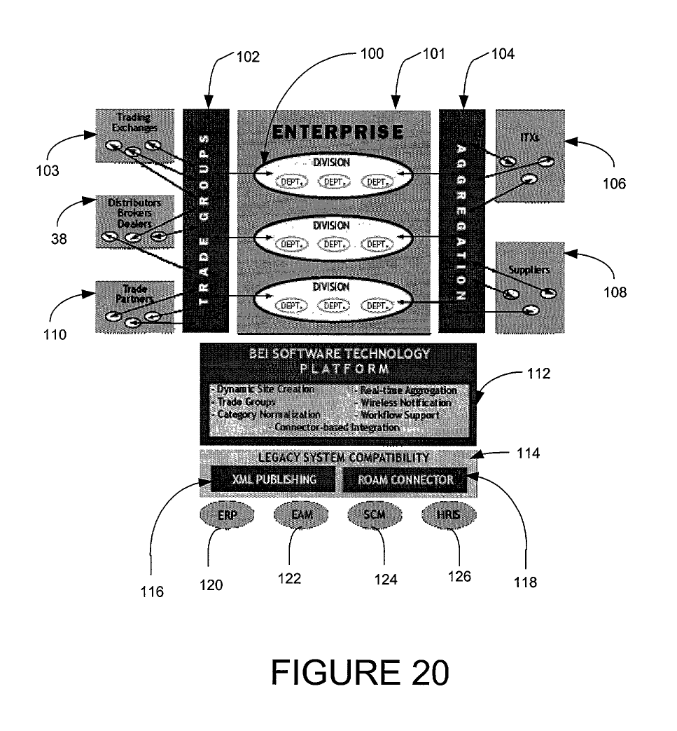

A more detailed description of a preferred system 10 will now be described with reference to FIGS. 20 to 23. The architecture and diagram of the asset management system 10 shown in these figures is just one possible implementation of the system 10. As will be appreciated by those skilled in the art, the methods according to the invention may be implemented with other types of systems and, moreover, the system architecture may vary from that shown in this example.

With reference to FIG. 20, the system 10 can be deployed across an enterprise 100 which may have multiple divisions and departments within each division. The system 10 enables the formation of trade groups which may involve any combination of divisions or departments within the enterprise 100, trading exchanges 103, distributors, brokers, and dealers 38, or trade partners 110. In other words, the enterprise 100 enables the creation of the internal trading community 12, the private trading community 14, and the public marketplaces 16, referenced in FIG. 1. The system 10 also enables aggregation 104, such as through industry trade exchanges 106 or suppliers 108. Some of the key features of the platform provided by the system 10 is shown at 112. These features include dynamic site creation, the formation of tradegroups, category normalization, connector-based integration, real-time aggregation, wireless notification, and workflow support. As shown at 114, the system 10 provides legacy system compatibility through XML publishing 116 and a ROAM connector 118. Some non-limiting examples of such legacy systems include an ERP system 120, an EAM system 122, a SCM system 124, and an HRIS system 126.

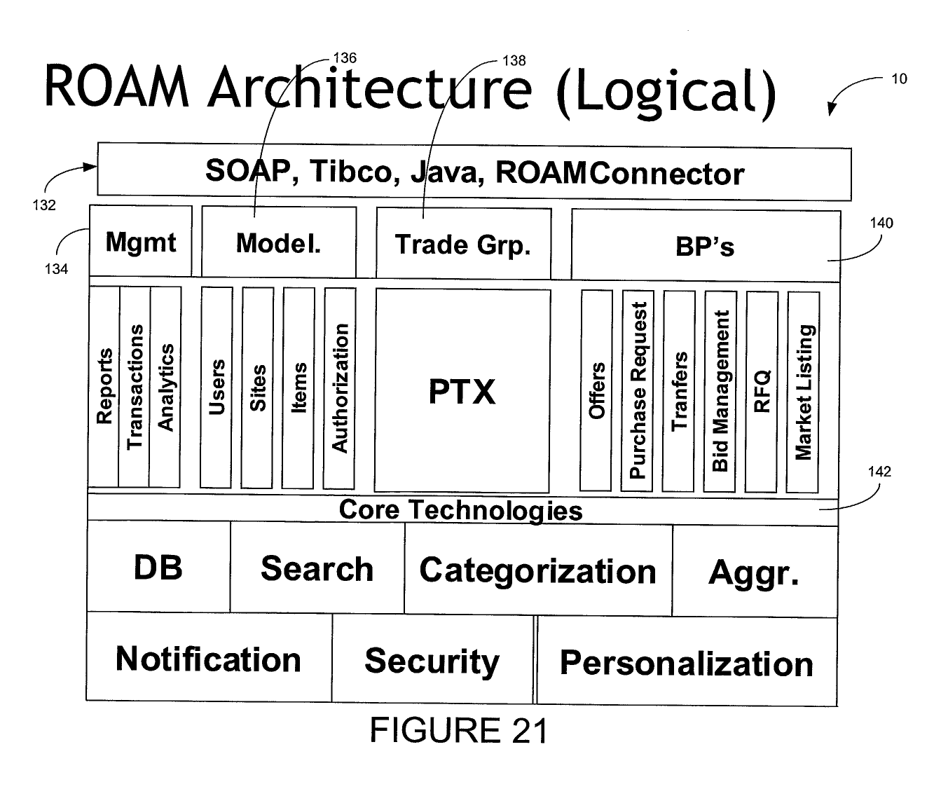

A logical diagram of the architecture for the system 10 is shown in FIG. 21. Starting from the bottom of this architecture are some of the core technologies 142 supporting the system 10. These technologies include databases (DB), a search engine, categorization functionality, aggregation functionality, notification unit, security unit, and personalization features.

FIG. 21 shows various uses of the system 10 by different user groups. For example, for management 134, these users may be interested in generating reports, completing transactions, and analytics. Another group of users 136 may be more concerned with security and administration of the system 10 and thus may monitor the users, sites, items listed, and authorization given to different users or groups. A further group 138 may be comprised of trade groups which are interested in establishing trade exchanges. A further group 140 comprised of business partners use the procurement and purchasing capability of the system 10 to make offers, purchase requests, transfers, bid management, RFQs and market listings.

An upper layer 132 shown in FIG. 21 corresponds to some of the software used including SOAP from Microsoft which is an XML-based protocol for exchanging structured and typed information on the web, Tibco from Tibco Software of Palo Alto, Calif., which provides integration products, JAVA from Sun Microsystem, or the ROAM connector for interfacing with legacy systems.

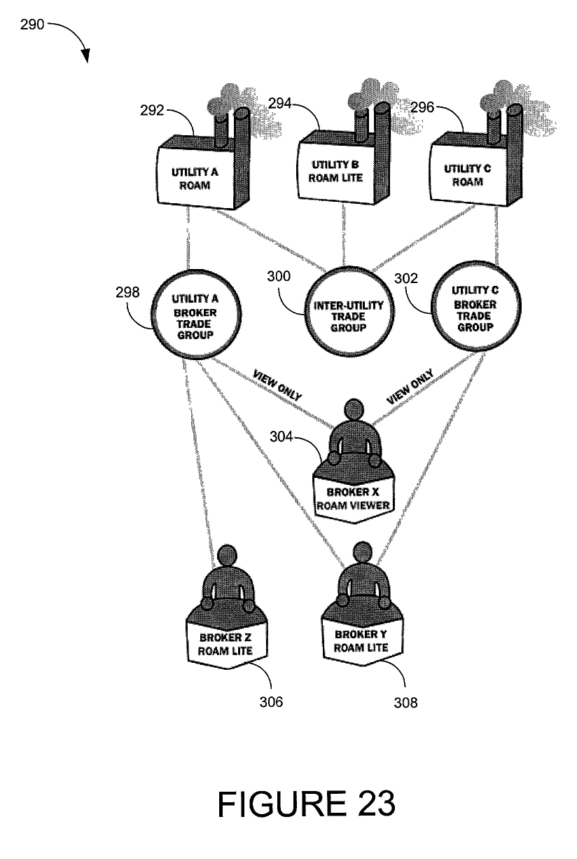

A database layer 242 maintains a persistent and consistent store of information required by an application. The database layer 242 is also a primary integration point between the ROAM system 10 and other applications in a network, such as crawlers. As such, the database layer 242 is responsible for storing a representation of the data that is application independent. The data type and uniqueness constraints are enforced within the database layer 242. The database layer 242 is independent as possible from the specific DBMS software chosen. Therefore, use of database-specific features and data types are preferably avoided. Also, the use of triggers and stored procedures should be limited since each trigger or stored procedure should be developed and tested for each DBMS software package chosen. The database layer 242, as shown in FIG. 23(B), may include a LDAP repository 274, a database 276, and an SAP Asset management database 278.

Data level classes 234 provide a thin application layer above the database layer 242 that is responsible for inserting, updating, reading, and deleting objects from the database 242. The database access 234 methods in these classes, such as read, insert, update, etc., should be suitable for inclusion within a database transaction, which means that they should not make calls to transaction-oriented methods on their own but instead should simply perform their work and pass through any SQL exceptions thrown as a result.

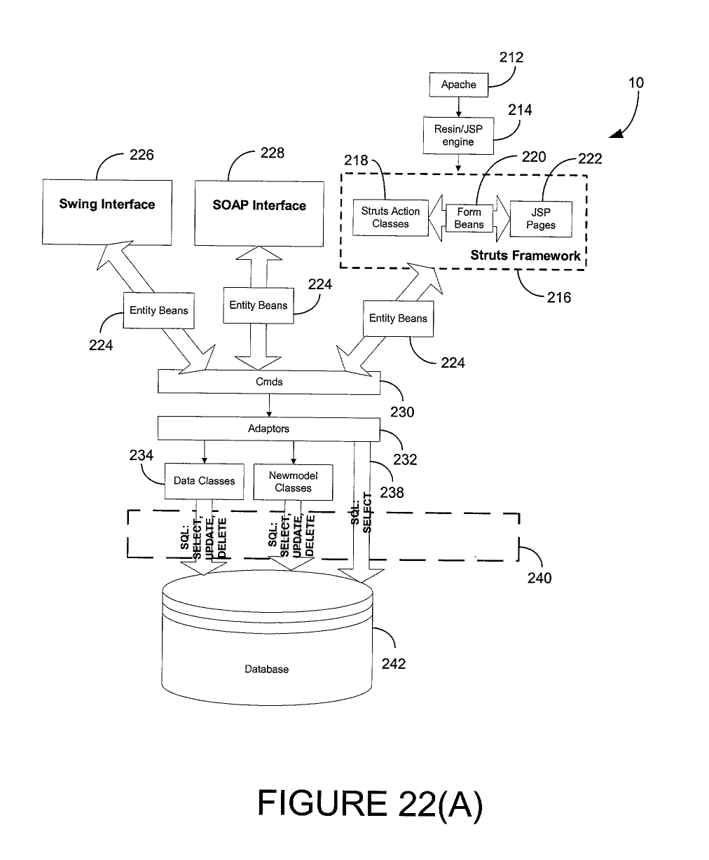

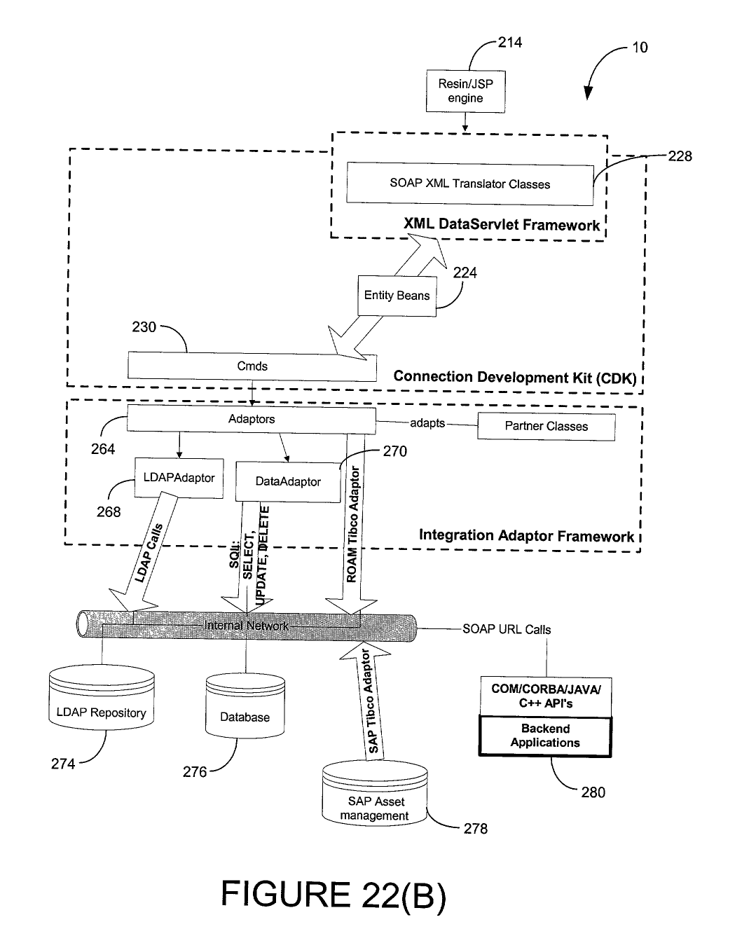

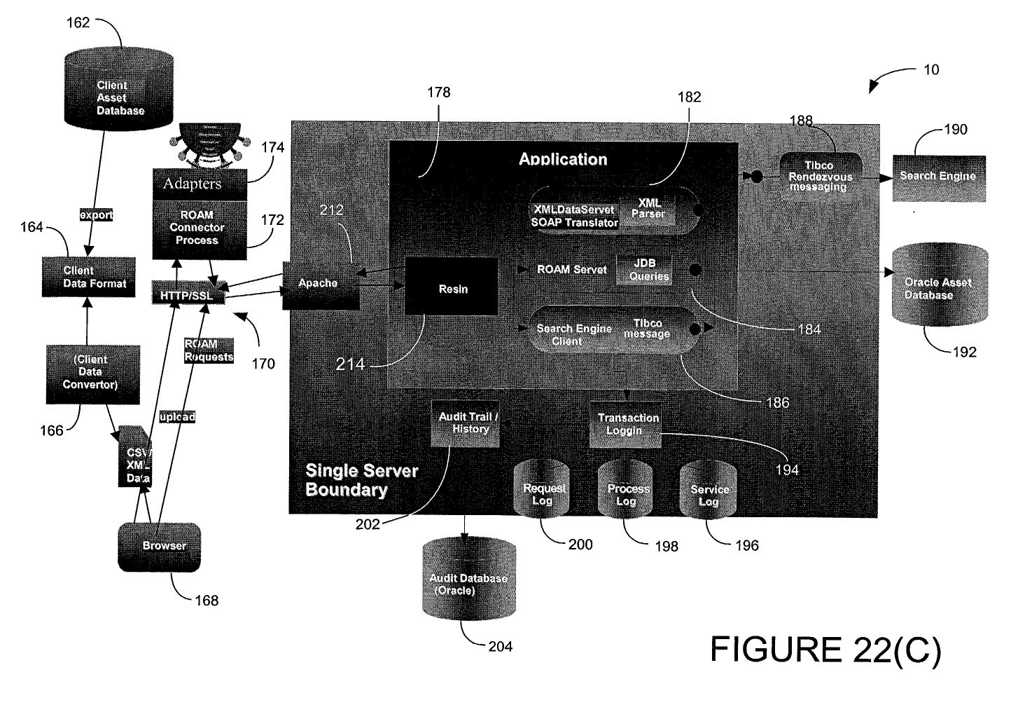

Data adaptor classes 232 work together to provide an interface between the front end interface of the application and the back end data storage and processing tasks. Each adaptor 232 preferably has a Java interface and one or more concrete implementations of the interface, with an adaptor class-specific factory for returning an implementation instance of the correct type. A benefit of this structure is that it provides a mechanism for customizing the application by implementing customer-specific adaptors 232 as needed. The adaptor interfaces should be designed to group together tightly coupled functionality into a single adaptor 232 to reduce the interdependencies between multiple adaptors. Adaptors 232 should use data level classes to update and store information in the database. The only interaction between an adaptor 232 and the database 242 should be SQL SELECT statements for queries that are not supported by any data level classes. Some examples of the data adaptor classes 232 include the adaptors 264, LDAP adaptor 268, and the data adaptor 270 shown in FIG. 22(B).

Command classes 230 encapsulate the public interface of the system 10. Each action that can be performed in the system 10 has a corresponding method in a command class 230. Each class 230 groups together the methods operating on an entity. For instance, a SiteCmd class 230 would have methods such as add, update, and delete. A purpose of the command layer 230 is to provide a uniform layer of entry points into the system backend. This consistent layer 230 will ease the development of alternative front ends for the system 10. For instance, an XML front-end layer such as SOAP 228 may be used to provide an integration point with other applications, or a Swing front end 226 may be created to provide a desktop-based interface to the system 10. The command layer 230 should make calls only into the adapter layer 232. In many cases, the methods in the command layer 230 will be very thin, and will simply delegate to the appropriate adaptor 232. In other cases, a command method may be responsible for performing methods on multiple entities as part of a single transaction.

Data beans 224 provide a representation of the application's entities, such as items, organizations, etc. The data beans 224 are collections of properties that make up the various entities, and don't contain much, if any, functional logic. They are used primarily as arguments to methods within the command layer 230. In addition to the get/set methods, each bean 224 will override the toString method to print out all data values which are set, not null or 0.

The action classes 218 implement the logic behind each page in the asset management system 10. In the Struts framework, each URL is mapped to an action class 218. The preferred pattern is that any URL request may perform some tasks, and then must return a resulting page. Struts uses the action classes 218 to encapsulate the tasks which should be performed for an action. An action class 218 performs some tasks and then redirects to a JSP page 222 which renders the results. Tasks that may be performed include making changes to some data beans 224, creating and filling in a form bean 220, or querying the database 242 and filling in some information to be sent to a JSP page 222.

Additional details on the system 10 architecture is shown in FIG. 22(C). The system 10 includes an XML parser 182, such as a SOAP translator, a servlet 184 for performing JDP queries, and a search engine client 186 which preferably performs Tibco messaging 188 with a search engine 190. The system 10 includes a transaction log unit 194 which maintains a request log 200, a process log 198, and a service log 196. The system 10 also includes an audit trail/history unit 202 for maintaining an audit database 204.

The system 10 can interface with user browsers 168 through http/SSL 170. ROA M requests are passed through the http/SSL layer 170 to a ROAM connector process 172 having adapters 174. Data from a client asset database 162 is exported in client data format 164 and a client data converter 166 converts the format into appropriate system format, such as CSW or XML, before being presented the browser 168.

(B) Security Considerations

A goal of the system's 10 security architecture is to provide a concise and clear and consistent set of rules for defining which tasks a user is allowed to perform, along with a simple to use interface for enforcing those rules. The system's 10 security model is rooted in a concept of roles. A user is assigned a role in relation to a particular site, and the tasks that a user is allowed to perform with a resource depends on the role that the user has for the site belonging to the resource.

The roles include an Administrator who creates, modifies, or deletes users or organizations with a parent. The Administrator role is granted implicitly as well as explicitly. That is, a user has Administrator privileges for any organization with a parent that the user has been assigned Administrator privileges. In other words, this privilege is “inherited” throughout the hierarchy.

An Approver originates purchase orders for a company in response to purchase requests originated by a Buyer. A user may only generate Purchase Orders for Organizations that they have the approver role for, and only in response to Purchase Requests originated by a Buyer for which the user is the designated Approver. The Approver role must be granted explicitly for an Organization. A user with the Approver role for an Organization does not automatically have Approver role for any sub-Organizations.

A Buyer role allows a user to originate Purchase Requests for items found in searching the database 242. Purchase Requests generated by a user may only be related to an Organization designating that user as a Buyer. The Buyer role is granted explicitly for an Organization. A user with the Buyer role for an Organization does not automatically have Buyer role for any of its sub-Organizations.

A Lister role allows a user to list new items as being available within an Organization. A user can only list items within Organizations for which they have the Lister role. The Lister role is granted explicitly for an Organization. A user with the Lister role for an Organization does not automatically have the Lister role for any of its sub-Organizations.

A Viewer role allows a user to search through the items listed for an Organization. If the user does not have Buyer role as well, then they will be unable to generate Purchase Requests for items that they find. The Viewer role is granted implicitly to a user for their parent Organization. Viewer role within an Organization implicitly grants Viewer role for all Organizations within the company.

In addition to roles, security considerations of the system 10 also relate to entities. An Organization represents a company division. The top-level organization, representing the entire company, has no parent Organization; all other Organizations have exactly one parent Organization and 0 or more child Organizations. A user must have Administrator role for a parent Organization to create a new child Organization, and have the Administrator role for an Organization in order to be allowed to edit or delete the Organization.

A User represents an employee that uses the system, including identification, authentication, and contact information. A user must have Administrator privileges for an Organization in order to create, modify, or delete user entities that are members of the Organization.

An Item entity represents an asset that is being tracked by the system 10. A user must have Lister role for an Organization to add, modify, or delete information about Items within the Organization. A user with Lister role may modify or delete information about any Items within the Organization, regardless of whether they were the user that initially entered the information.

A Purchase Request entity represents a transaction where an asset is transferred from one Organization to another. It may involve a series of interactions between a Buyer and their designated Approver regarding details about the item in question. A user must have Buyer role for an organization to create a Purchase Request within the Organization.

In addition to entities and roles, the system 10 also considers user groups in providing security. User groups are provided as a convenience feature that allows Administrators to collect similar users together for the purpose of creating and editing role information for all users in the group at once. Groups are created by manually entering individual members into a group. Groups may also include other User Groups. A user is considered to have been granted a role if they are included in a user group that has been granted the role.

Trading groups is another security consideration of the system 10. Trading groups provide a facility for sharing information about listed items between Organizations that are in different companies. A Trading Group is essentially an Organization that has no children Organizations for which the Administrator grants roles to Users from various Organizations. Trading Groups are implemented separately in the UI to provide support for adding users from other Organizations to the Group.

The goals behind the development of a security infrastructure implementation are to provide a single consistent piece of code for modeling business security rules, to provide a simple, easy-to-use mechanism for developers to include security checking in their code, and to ensure that all actions that are performed in the application correctly check for user privileges before performing any tasks. A preferred implementation attempts to accomplish these goals by providing a mechanism where the role requirements for any action are specified in a struts-config-bei.xml file, along with the action's definition. Three pieces of information are specified for each action defined in the file: the role required for the action, the type of entity being acted on, and how to find the ID for the specific entity that is being manipulated.

An example action definition entry follows:

```
<action path = “/b2b/tradegroup”
    type = “bidder.b2b.actions.TradingGroupAction”
  name = “tradingGroupForm”
  input = “/b2b/tradinggroupedit.jsp”>
<set-property property = “role” value = “Admin”/>
<set-property property = “entityType” value = “Organization”/>
<set-property property = “entityIDParam” value = “id”/>
</action>
```

In addition to the standard properties for setting up the mapping, the developer specifies three additional properties. The first is role, which specifies the user role that is required to execute the action. Valid values include Admin, Lister, Buyer, Approver, and Viewer. If not provided, the role defaults to “Admin”. The second is entityType, which specifies the type of entity that the action manipulates. Valid values include Organization, User, Item, and Purchase Request. If not provided, it defaults to “Organization”. The third property is entityIDParam, which specifies the name of the request parameter that will include the ID of the entity to be manipulated. If not specified, then a value of id is used.

If these properties are specified in the config file, and an action class 218 extends the BEAction class, then the security infrastructure will implicitly ensure that the user is authorized to perform an action before passing control over to the action class 218. Since security checking is performed as part of the Struts Action framework, it is imperative that all UI actions actually pass through the framework and no links should be made directly to JSP pages 222. Instead, an action should be configured in the config file to display a JSP page 222. An empty action class 218 should be created for use in those cases where no processing is required by the action class 218. To enforce this rule, Resin 214 and/or Apache 212 should be configured to throw an error when a request is made for a JSP pages 222 from a web browser.

(C) Data Input Validation

Several types of validation exists with the system 10. Data type validation detects errors converting HTML string variables to data types other than String (int, double, etc) when setting the bean values. Application validation detects errors such as missing required values or data integrity constraint violations that are defined by the system 10. Database constraint validation detects errors which violate database constraints. Business validation detects errors specific to a specific customer's environment; such as work flow requirements.

Each data bean 224 has a validation bean 224 defined for it which will perform the data type conversion and application validations. The first type, data type validation, is covered by using the parsing methods in com.bei.roam. Misc. These methods already handle errors converting a String to a non-String data type. Database constraints are validated in the adaptor layer 264, with user correctable errors thrown back to the UI layer as BeiExceptions. Business validations are performed in the adaptor layer 264, with user correctable errors thrown back to the UI layer as BeiExceptions.

(D) Handling Session State

Resin 214, like many servlet engines, provides support for storing session variables, which are objects stored in the servlet engine's memory on the application server and made available to servlets or JSP pages 222 based on a session cookie that is set on a user's browser when they first access the site. Session variables are a convenient method of storing application state across multiple page visits. Most high-availability, high-reliability web applications use HTTP redirectors to provide load balancing between web servers and failover in case of web server failure. The use of redirectors in a system implies that the actual target machine of any web request is not predictable. Applications that utilize session variables do not work well in these environments since session variables assume that each user request is processed on the same application server.

VI. Exemplary Alternative Embodiments of the Asset Managing System

Alternative embodiments according to the exemplary invention will now be described with reference to FIG. 24. As discussed in the references above, the preferred embodiment of the asset managing system 10 allows organizations to easily and rapidly create their own confidential and secure private, ad-hoc trading groups. These real time listing areas are visible only to pre-authorized users within partner divisions, companies or brokerages. Buyers in the environment can then easily search for item availability across trade groups as well as internal and other external sources.

However, an entity may not require the full capabilities of the asset managing system 10 of the preferred embodiment of the invention. In an alternative embodiment of the asset managing system 10, an entity may subscribe to a version of the asset managing system 10 with reduced functional capability. For example, the entity may only require a version of the asset managing system that provides viewing functionality. This version of the asset managing system 10 is termed ROAM Viewer. As a further example, the entity may subscribe to a version of the asset managing system 10, termed ROAM Lite, that provides viewing functionality as well as listing capabilities. As with the asset managing system 10 termed ROAM, these names were provided by BEI Software but may have other names and may be sold, licensed, distributed or otherwise used by other entities.

Signing up for ROAM Viewer may provide access to trade groups within minutes. Moreover, buyers may also have the option of upgrading from ROAM Viewer to ROAM Lite to include listing capabilities as well. The functional capabilities not offered by ROAM Viewer and ROAM Lite may include internal redeployment of idle assets, the ability to create internal trading groups and back-end integration.

FIG. 24 illustrates a network of utility companies and brokers 290 as an example of the interactions between three entities and their buyers using ROAM, ROAM Lite and ROAM Viewer. In this example Utilities A 292 and Utility C 296 are ROAM customers and have the ability to create a trading group into which they can view and list idle and surplus assets. Utility B 294, while not initially a ROAM customer, has subscribed to ROAM Lite to participate in the Inter-Utility Trade Group 300.

Utilities A 292 and Utility C 296 also created Broker Trade Group 298 and Broker Trade Group 302, respectively, for the purpose of sharing items with their broker networks. Broker X 304 has subscribed to ROAM Viewer and has the ability to view items in Broker Trade Group 298 as well as Broker Trade Group 302. Broker Y 308 has subscribed to ROAM Lite to add listing capabilities into both of these trading groups. Broker Z 306 also has both viewing and listing capabilities. However, Broker Z 306 does not have a relationship with Utility C 296 and therefore was not invited to participate in Utility C's Broker Trade Group 302.

The foregoing description of a preferred embodiments of the invention has been presented only for the purpose of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated.

What is claimed is:

1. A method of managing assets for an entity, comprising:
providing an on-line internal trading community;
enabling the entity to form an on-line private trading community with authorized business partners;
enabling the entity to participate in an on-line public marketplace;
permitting the entity to list select assets with each of the on-line internal trading community, the on-line private trading community, and the on-line public marketplace;
allowing the entity to view available assets listed on the on-line internal trading community, the on-line private trading community, and the on-line public marketplace; and
providing workflow for automating aspects of executing a transaction through any one of the on-line internal trading community, the on-line private trading community, and the on-line public marketplace.

2. The method as set forth in claim 1, wherein providing the on-line internal trading community comprises defining authorized users and roles of the users.

3. The method as set forth in claim 1, wherein enabling the entity to form the on-line private trading community comprises participating in an on-line exchange.

4. The method as set forth in claim 1, wherein enabling the entity to form the on-line private trading community comprises forming a business relationship with a broker of assets.

5. The method as set forth in claim 1, wherein permitting the entity to list select assets comprises enabling the entity to place each asset on any of the on-line private trading community, the on-line internal trading community, and the on-line public marketplace.

6. The method as set forth in claim 1, wherein allowing the entity to view assets comprises providing a search capability for enabling a user to search for desired assets.

7. The method as set forth in claim 6, wherein providing the search capability comprises providing a capability of browsing through categories of assets.

8. The method as set forth in claim 6, wherein providing the search capability comprises providing a capability of searching by keyword.

9. The method as set forth in claim 6, wherein providing the search capability comprises providing a capability of tracking certain assets.

10. The method as set forth in claim 6, wherein providing the search capability comprises providing a capability of being alerted when desired assets become listed in one of the on-line private trading community, the on-line internal trading community, and the on-line public marketplace.

11. The method as set forth in claim 1, wherein providing workflow comprises providing workflow for inspecting assets prior to listing the assets.

12. The method as set forth in claim 1, wherein providing workflow comprises providing workflow for procuring assets.

13. The method as set forth in claim 1, wherein providing workflow comprises providing workflow for listing assets.

14. The method as set forth in claim 1, wherein providing workflow comprises providing an approval workflow for obtaining necessary authorizations within the entity.

15. The method as set forth in claim 1, further comprising categorizing assets being listed in at least one of the of the on-line private trading community, the on-line internal trading community, and the on-line public marketplace.

16. The method as set forth in claim 15, further comprising normalizing the categorization of the assets being listed in at least one of the of the on-line private trading community, the on-line internal trading community, and the on-line public marketplace.

17. The method as set forth in claim 1, further comprising providing reporting functionality for enabling a user to manage use of the on-line private trading community, the on-line internal trading community, and the on-line public marketplace.

18. The method as set forth in claim 1, further comprising integrating the on-line private trading community, the on-line internal trading community, and the on-line public marketplace with legacy systems.

19. The method as set forth in claim 1, further enabling the entity to view details on assets listed in any of the on-line private trading community, the on-line internal trading community, and the on-line public marketplace.

20. The method as set forth in claim 1, wherein permitting the entity to list comprises enabling the entity to list each asset selectively on any one or combination of the on-line private trading community, the on-line internal trading community, and the on-line public marketplace.
